(19) United States
(12) Patent Application Publication
(10) Pub. No.: US 2026/0040207 A1
(43) Pub. Date: Feb. 5, 2026

(54) EDGE COMPUTING ASPECTS WITH MULTI-ACCESS DELIVERY IN MEDIA STREAMING NETWORKS

(71) Applicant: Samsung Electronics Co., Ltd., Suwon-si (KR)

(72) Inventor: Prakash Reddy Kolan, Plano, TX (US)

(21) Appl. No.: 19/272,975

(22) Filed: Jul. 17, 2025

Related U.S. Application Data
(60) Provisional application No. 63/678,849, filed on Aug. 2, 2024.
(60) Provisional application No. 63/720,464, filed on Nov. 14, 2024.

(51) Int. Cl. H04W 48/20; H04L 43/0811; H04W 8/22; H04W 24/08; H04W 28/02

(52) U.S. Cl. CPC H04W 48/20; H04L 43/0811; H04W 8/22; H04W 24/08; H04W 28/0268

(57) ABSTRACT

An apparatus includes a transceiver configured to receive a request for application data from a user equipment (UE). The apparatus also includes a processor operably coupled to the transceiver. The processor is configured to obtain a set of candidate access networks and a corresponding set of edge data networks (EDNs) capable of serving the application data, and determine, based on one or more of: (i) availability of the EDNs, (ii) a coverage area, (iii) one or more application requirements, and (iv) one or more network conditions, to deliver the application data via multi-access delivery. The processor is also configured to select two or more access network-EDN combinations to support the multi-access delivery, distribute portions of the application data across the selected access network-EDN combinations, and adapt the distribution of the application data based on monitoring of quality of service (QOS) metrics for the access network-EDN combinations.

### CROSS-REFERENCE TO RELATED APPLICATIONS AND CLAIM OF PRIORITY

This application claims priority under 35 U.S.C. § 119 (e) to U.S. Provisional Patent Application No. 63/678,849 filed on Aug. 2, 2024, and U.S. Provisional Patent Application No. 63/720,464 filed on Nov. 14, 2024. The above-identified provisional patent applications are hereby incorporated by reference in their entirety.

### TECHNICAL FIELD

This disclosure relates generally to wireless networks. More specifically, this disclosure relates to edge computing aspects with multi-access delivery in media streaming networks.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for edge computing aspects with multi-access delivery in media streaming networks.

In one embodiment, an apparatus is provided. The apparatus includes a transceiver configured to receive a request for application data from a user equipment (UE). The apparatus also includes a processor operably coupled to the transceiver. The processor is configured to obtain a set of candidate access networks and a corresponding set of edge data networks (EDNs) capable of serving the application data, and determine, based on one or more of: (i) availability of the EDNs, (ii) a coverage area, (iii) one or more application requirements, and (iv) one or more network conditions, to deliver the application data via multi-access delivery. The processor is also configured to select two or more access network-EDN combinations to support the multi-access delivery, distribute portions of the application data across the selected access network-EDN combinations, and adapt the distribution of the application data based on monitoring of quality of service (QOS) metrics for the access network-EDN combinations.

In another embodiment, a method of operating an apparatus is provided. The method includes receiving a request for application data from a UE, obtaining a set of candidate access networks and a corresponding set of EDNs capable of serving the application data, and determining, based on one or more of: (i) availability of the EDNs, (ii) a coverage area, (iii) one or more application requirements, and (iv) one or more network conditions, to deliver the application data via multi-access delivery. The method also includes selecting two or more access network-EDN combinations to support the multi-access delivery, distributing portions of the application data across the selected access network-EDN combinations, and adapting the distribution of the application data based on monitoring of QOS metrics for the access network-EDN combinations.

In yet another embodiment, a non-transitory computer readable medium embodying a computer program is provided. The computer program includes program code that, when executed by a processor of a device, causes the device to receive a request for application data from a UE, obtain a set of candidate access networks and a corresponding set of EDNs capable of serving the application data, and determine, based on one or more of: (i) availability of the EDNs, (ii) a coverage area, (iii) one or more application requirements, and (iv) one or more network conditions, to deliver the application data via multi-access delivery. The program code, when executed by the processor of the device, also causes the device to select two or more access network-EDN combinations to support the multi-access delivery, distribute portions of the application data across the selected access network-EDN combinations, and adapt the distribution of the application data based on monitoring of QoS metrics for the access network-EDN combinations.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates an example 5GMS architecture according to embodiments of the present disclosure;

FIG. 5 illustrates an example architecture for accessing edge application servers according to embodiments of the present disclosure;

FIG. 6 illustrates an example application layer architecture for enabling edge applications according to embodiments of the present disclosure;

FIG. 7 illustrates example connectivity models for edge computing according to embodiments of the present disclosure;

FIG. 8 illustrates an example deployment of application services according to embodiments of the present disclosure;

FIG. 9 illustrates examples of intra-PLMN and inter-PLMN scenarios for using multiple access networks according to embodiments of the present disclosure;

FIG. 10 illustrates an example dual steering architecture according to embodiments of the present disclosure;

FIG. 11 illustrates an example architecture for enabling edge applications according to embodiments of the present disclosure;

FIG. 12 illustrates an example architecture for enabling cloud application with edge applications according to embodiments of the present disclosure;

FIG. 13 illustrates an example of transmission of edge server update information to enable selection of an appropriate edge service in lieu of network access changes according to embodiments of the present disclosure;

FIG. 14 illustrates an example of service configuration of edge services per access according to embodiments of the present disclosure;

FIG. 15 illustrates an example of a UE in service areas of two different EDNs/LADNs according to embodiments of the present disclosure;

FIG. 16 illustrates an example of a multi-access delivery when a UE in the service areas of two different EDNs/LADNs according to embodiments of the present disclosure;

FIG. 17 illustrates an example of an application state transfer to enable seamless multi-access delivery according to embodiments of the present disclosure;

FIG. 18 illustrates an example of processing adaptation in multiple edge data networks with multi-access delivery according to embodiments of the present disclosure;

FIG. 19 illustrates an example of application state transfer using application managers in edge data networks according to embodiments of the present disclosure;

FIG. 20 illustrates an example UE initiated procedure for multi-access with access to multiple edge data networks according to embodiments of the present disclosure;

FIG. 21 illustrates an example of application service provider configuration of service according to embodiments of the present disclosure;

FIG. 22 illustrates an example method for service content duplication through a local UPF and central UPF according to embodiments of the present disclosure;

FIG. 23 illustrates an example method for a service update to avoid using a local DN because of bandwidth estimation according to embodiments of the present disclosure;

FIG. 24 illustrates an example method for a service update when a breakdown/unavailable communication between a local DN and remote DN is inferred according to embodiments of the present disclosure;

FIG. 25 illustrates an example method for service content duplication through a local UPF and central UPF according to embodiments of the present disclosure;

FIG. 26 illustrates an example method for a service update when a breakdown/unavailable communication between a local DN and remote DN is inferred according to embodiments of the present disclosure; and

FIG. 27 illustrates an example method for edge computing with multi-access delivery according to embodiments of the present disclosure.

### DETAILED DESCRIPTION

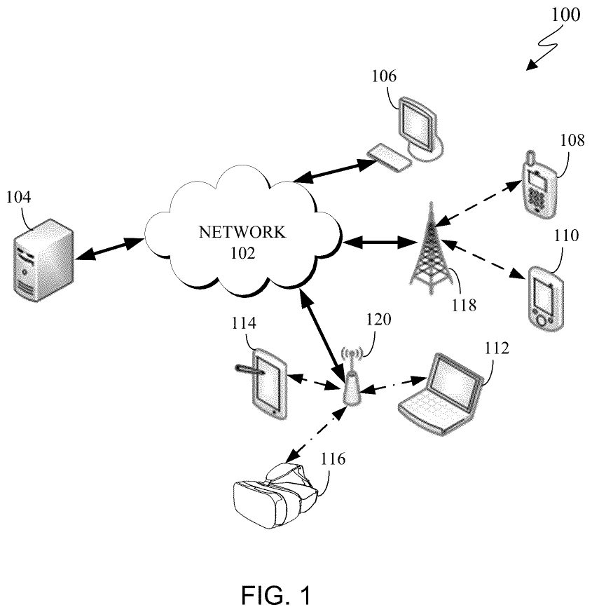

FIGS. 1 through 27, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

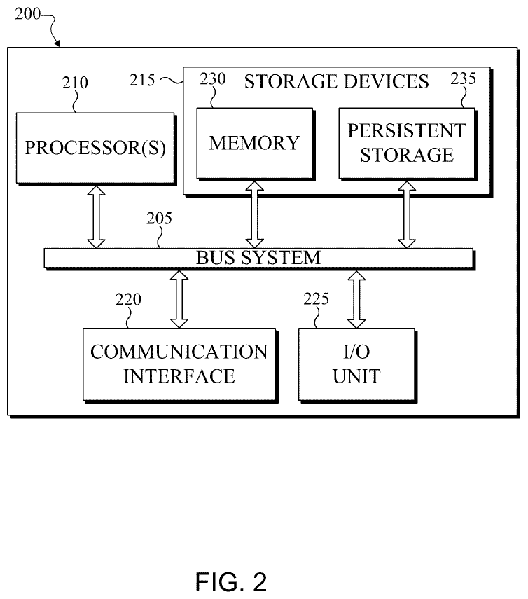

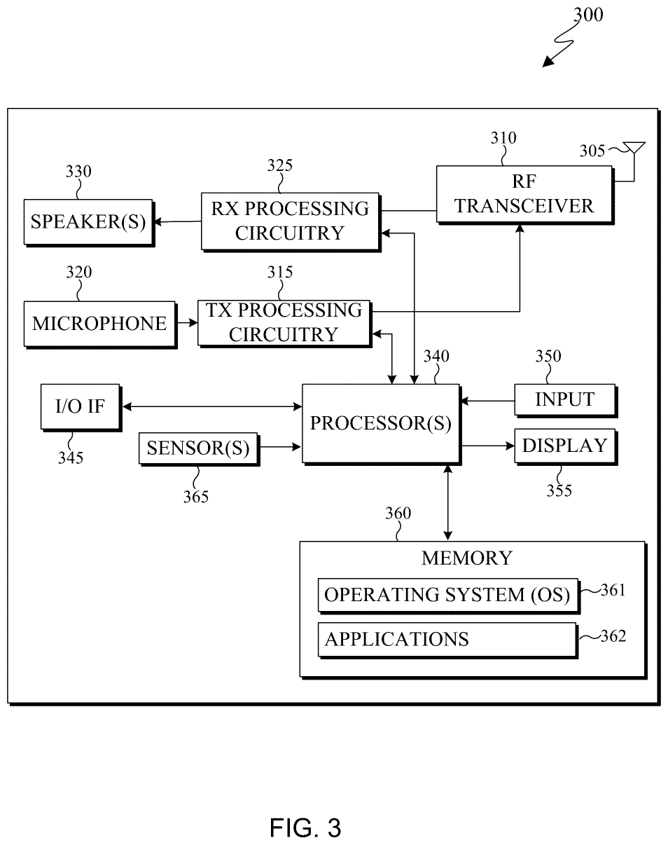

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user to interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

In various embodiments of the present disclosure, a communication system such as communications system 100 may include one or more of an Application Function (AF), Access and Mobility Function (AMF), Policy Control Function (PCF), Session Management Function (SMF), and a User Plane Function (UPF). As described herein, an AF, AMF, PCF, SMF, and a UPF can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain functions may be executed by hardware components to achieve high performance, while other functions may be performed by software modules to provide flexibility and ease of updates.

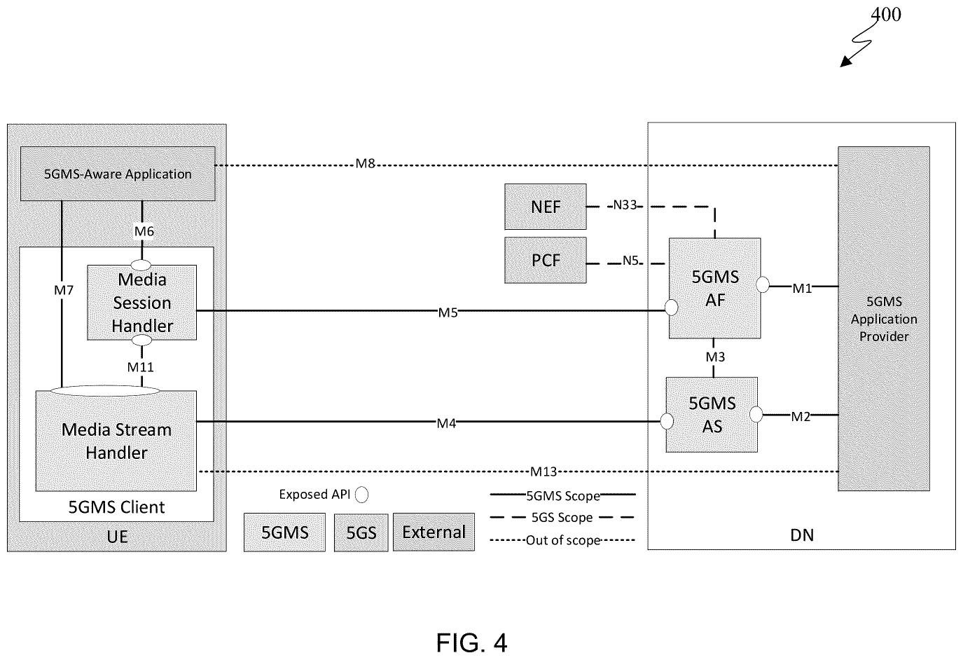

In various embodiments of the present disclosure, a communication system such as communications system 100 may be used to perform 5G Media Streaming (5GMS) based on the 5GMS architecture shown in FIG. 4.

FIG. 4 illustrates an example 5GMS architecture 400 according to embodiments of the present disclosure. The embodiment of a 5GMS architecture of FIG. 4 is for illustration only. Different embodiments of a 5GMS architecture could be used without departing from the scope of this disclosure.

In some embodiments, 5GMS architecture 400 may include one or more of the following components (some of which are not shown in FIG. 4):
5GMS AF: An Application Function dedicated to 5G Media Streaming. In the present disclosure, a 5GMS AF may also be referred to simply as an Application Function or AF. Any other generic Application Function may also be referred to herein as AF.
5GMS AS: An Application Server (AS) dedicated to 5G Media Streaming. In the present disclosure, a 5GMS AS may also be referred to simply as an Application Server or AS.
5GMS Client: A UE internal function dedicated to 5G Media Streaming. The 5GMS Client is a logical function and its sub-functions may be distributed within the UE according to implementation choice.
Media Stream Handler: A UE internal function that is part of the 5GMS Client and responsible for media stream handling functionality.
3GPP Access Node: An access network node in a 3GPP RAN (e.g., 4G LTE, 5G, NR, etc. base station such as base station 118).
Non-3GPP Access Node: An access network node that enables connectivity to a Non-3GPP access endpoint (such as wireless access point 120) to a 3GPP network (e.g., via a Non-3GPP Interworking Function [N3IWF] of a 3GPP network).
5GMS Application Provider: A service provider providing 5G media streaming services.
SMF: A Session Management Function in a 3GPP network.
UPF: A User Plane Function in 3GPP network.
5GMS ASP: An Application Service Provider (ASP) that provides 5G Media Streaming services to subscribed users using a 5GMS system. In the present disclosure, a 5GMS ASP may also be referred to simply as an Application Service Provider or ASP.

By utilizing 5GMS architecture 400, media services can be provisioned by an application service provider at a 5G AF using the M1 interface and content is ingested to a 5G AS using the M2 interface. After any processing to the ingested media (as provisioned by the application service provider and enforced by the 5G AF), the content is then distributed to end users using the M4 interface. The end user device UE uses the M5 and M4 interfaces to communicate back with the control and user plane functions (i.e., the 5G AF and 5G AS) in the core network.

Although FIG. 4 illustrates an example 5GMS architecture 400, various changes may be made to FIG. 4. For example, architecture 400 could include additional core network functions, etc. according to particular needs.

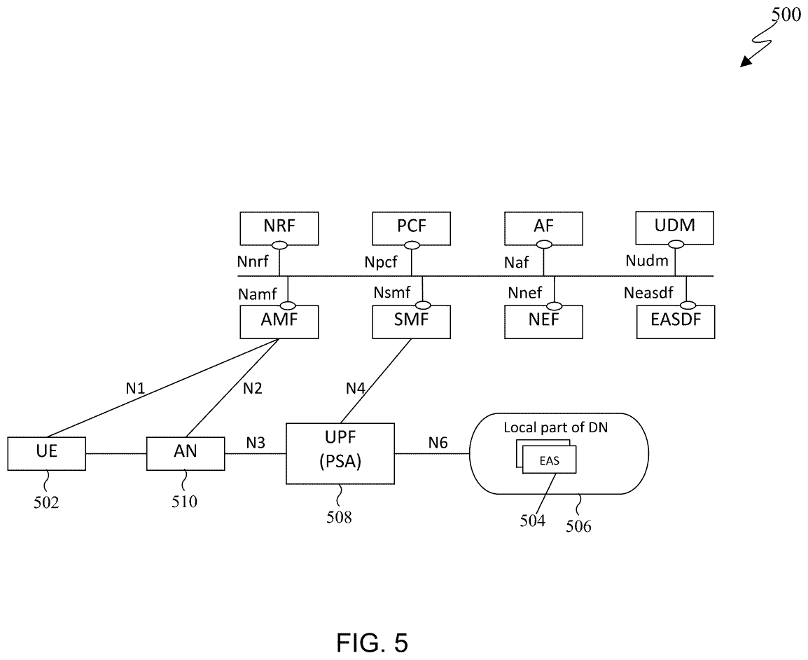

A reference architecture for accessing an edge application server in existing wireless networks has been standardized as shown in FIG. 5.

FIG. 5 illustrates an example architecture 500 for accessing edge application servers according to embodiments of the present disclosure. The embodiment of accessing edge application servers of FIG. 5 is for illustration only. Different embodiments of an architecture for accessing edge application servers could be used without departing from the scope of this disclosure.

As shown in the example of FIG. 5, the UE 502 can connect to an edge application server (EAS) 504 in an edge data network (DN) 506 using a user plane function (UPF) 508 that operates as a PDU session anchor (PSA). Application sessions span the UE 502, the Access Node (AN) 510 (e.g., the gNB), UPF508, and the EAS 504 in the edge DN 506.

Although FIG. 5 illustrates an example architecture 500 for accessing edge application servers, various changes may be made to FIG. 5. For example, architecture 500 could include additional edge data networks, etc. according to particular needs.

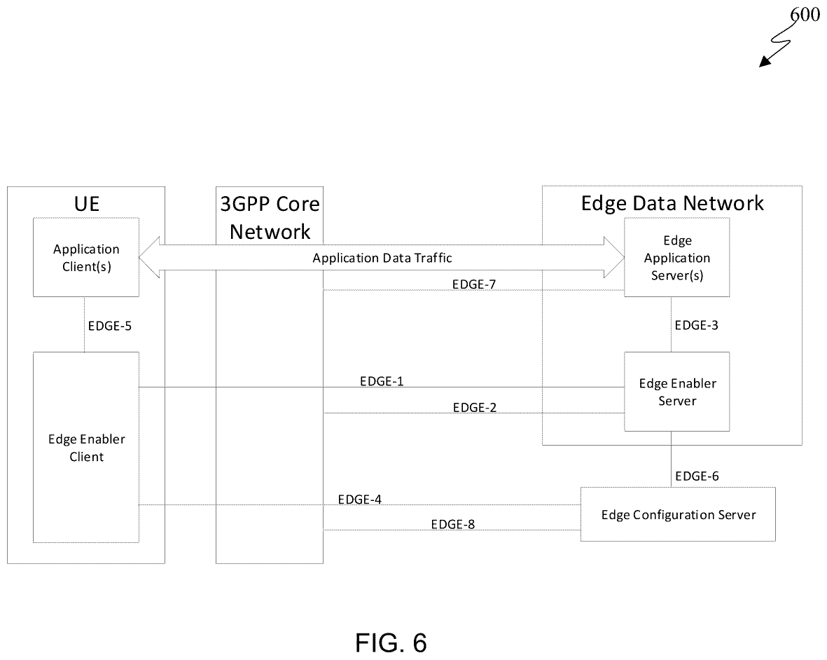

Edge deployment is an enabler for providing services to end users that are otherwise difficult to offer service to due to latency and buffering requirements. A reference application layer architecture for enabling edge applications in wireless networks has been standardized as shown in FIG. 6.

FIG. 6 illustrates an example application layer architecture 600 for enabling edge applications according to embodiments of the present disclosure. The embodiment of enabling edge applications of FIG. 6 is for illustration only. Different embodiments of an application layer architecture for enabling edge applications could be used without departing from the scope of this disclosure.

In the example of FIG. 6, applications are hosted close to the end user (e.g., close to the gNB). This allows the application to have lower end-to-end latencies compared to if the applications were hosted in a remote cloud (e.g., a service provider cloud or network).

Although FIG. 6 illustrates an example architecture 600 for enabling edge applications, various changes may be made to FIG. 6. For example, architecture 600 could include additional edges, etc. according to particular needs.

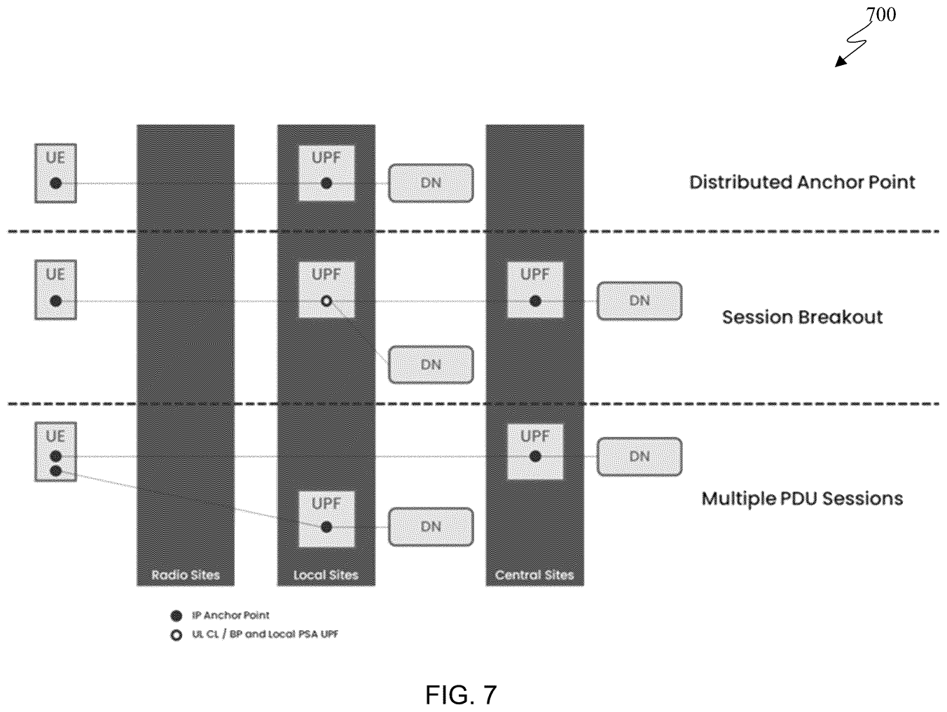

5G network connectivity models have been specified as shown in FIG. 7.

FIG. 7 illustrates example connectivity models 700 for edge computing according to embodiments of the present disclosure. The embodiment of edge computing of FIG. 7 is for illustration only. Different embodiments of connectivity models for edge computing could be used without departing from the scope of this disclosure.

As shown in FIG. 7, a 5G network supports three kinds of connectivity models using different network functions available in the operator network:
Distributed Anchor Point: In this connectivity model, a PDU Session Anchor User Plane Function (PSA UPF) is in a local site and all UE traffic is routed to the local site (i.e., the local DN).
Session breakout: In this connectivity model, a PSA UPF exists in the local site, another PSA UPF exists in the central site, and all the traffic of an edge computing application in the UE is routed to the PSA UPF in the local site using mechanisms such as Uplink Classifier or Branching Point. The PSA UPF in the local site is responsible for diverting UE edge computing application traffic towards the local DN and other traffic towards the central PSA UPF.
Multiple PDU sessions: In this connectivity model, similar to the session breakout model, a PSA UPF exists in the local site and another PSA UPF exists in the central site. However, in this case, the PSA UPF in the local site only receives traffic from certain applications (edge computing applications) and all other traffic from the UE goes directly to the central PSA UPF.

Although FIG. 7 illustrates example connectivity models 700 for edge computing, various changes may be made to FIG. 7. For example, connectivity models 700 could include PSA UPFs in other locations, etc. according to particular needs.

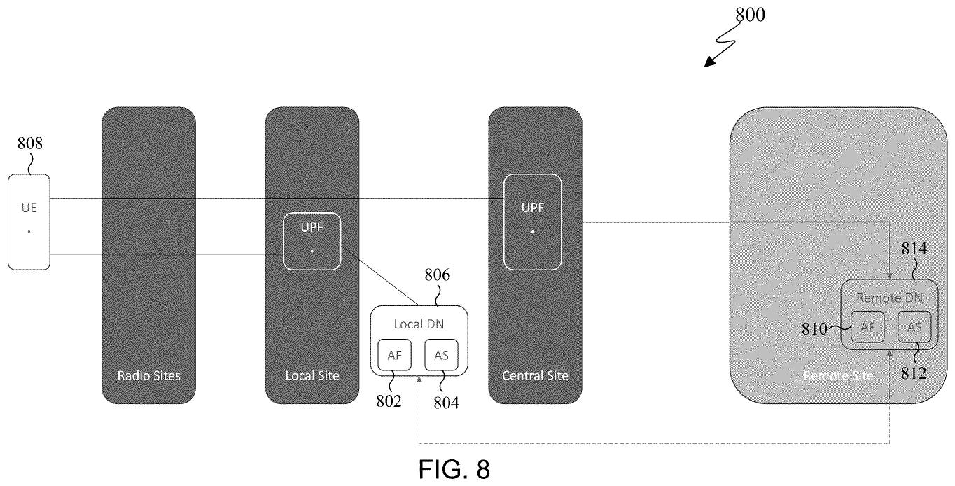

When a service (e.g., 5G Media Streaming) is provided by an applications service provider (ASP) to mobile network users, typically, the ASP makes available to the mobile users a set of application functions (AFs) and application servers (ASs). These AF and AS functions are made available in a remote site or network or data network (DN) (e.g., a remote cloud such as Amazon Cloud) which are directly under the control of the ASP, or in local DNs based on negotiation with the network operator as shown in FIG. 8.

FIG. 8 illustrates an example deployment of application services 800 according to embodiments of the present disclosure. The embodiment of a deployment of application services of FIG. 8 is for illustration only. Different embodiments of a deployment of application services could be used without departing from the scope of this disclosure.

In the example of FIG. 8, AF 802 and AS 804 reside on local DN 806 and provide a service (e.g., 5G Media Streaming) to UE 808. UE 808 may also access the service via AF 810 and AS 812 which reside on remote DN 814. Whether UE 808 accesses the service via the local DN 806 or the remote DN 814 may be established by the ASP (not shown).

The local DN 814 may be operated by a different entity other than the ASP (e.g., an edge computing provider). It is also possible that the ASP may act as an edge computing provider (ECP) and provide edge hosting infrastructure services to the mobile operator. In cases where the ASP sessions benefit from edge computing capabilities (for example, services with high throughput, low latency services), the AF 802 and AS 804 functions in the local DN 806 are used. Other services may not be impacted if the service streams go through the central site and then to the remote site.

Although FIG. 8 illustrates an example deployment of application services 800, various changes may be made to FIG. 8. For example, deployment 800 could include additional application services, etc., according to particular needs.

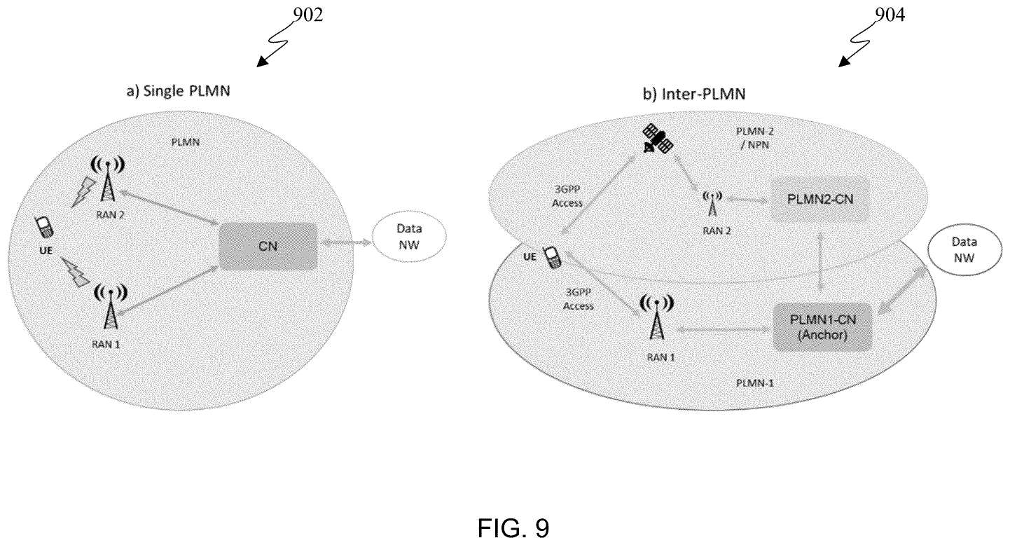

Wireless networks may support a set of use cases and service requirements related to 5G system support of traffic switching, splitting, and steering of a UE's user data across multiple 3GPP access networks. FIG. 9 shows examples of intra-public land mobile network (PLMN) and inter-PLMN scenarios for using multiple access networks.

FIG. 9 illustrates examples 902-904 of intra-PLMN and inter-PLMN scenarios for using multiple access networks according to embodiments of the present disclosure. The embodiments of intra-PLMN and inter-PLMN scenarios of FIG. 9 are for illustration only. Different embodiments of intra-PLMN and inter-PLMN scenarios for using multiple 3GPP access networks.

In the examples of FIG. 9 the UE is connected to more than one access network at the same time. Traffic from different applications installed on the UE may use one or more access networks to connect to the UE's service endpoints, either inside the operator network, or through the operator network into the external Internet. The type of access networks are not limited to terrestrial mobile networks, but could also be satellite networks, Non-public networks (NPNs) etc. In example 902, the UE is connected to multiple access networks of the same PLMN, while in example 904, the UE is connected to access networks of different PLMNs.

Although FIG. 9 illustrates examples 902-904 of intra-PLMN and inter-PLMN scenarios for using multiple 3GPP access networks, various changes may be made to FIG. 9. For example, examples 902-904 could include additional access networks, different access networks, etc. according to particular needs.

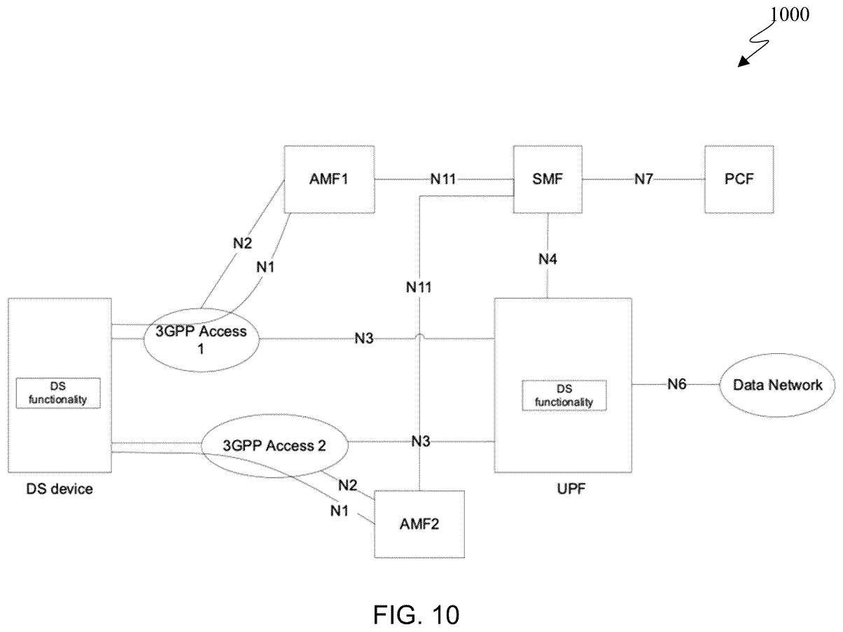

Wireless networks may support operation of a dual steering (DS) device that is capable of traffic steering and switching of user data for different services across two 3GPP access networks as shown in FIG. 10.

FIG. 10 illustrates an example dual steering architecture 1000 according to embodiments of the present disclosure. The embodiment of a dual steering architecture of FIG. 10 is for illustration only. Different embodiments of a dual steering architecture could be used without departing from the scope of this disclosure.

In the example of FIG. 10, the dual steering functionality (DS functionality) inside the DS device allows connection to the operator network UPF using multiple 3GPP access networks. With the DS functionality, the network may see that the network is interacting with two different 3GPP UE endpoints when in fact it is the same UE that has credentials to access content over multiple access networks. The DS functionality enables separate registration and UE session management over each of the connected 3GPP access networks. With Dual Steer and multipath delivery as shown FIG. 10, clients are able to use the capabilities of two or more access networks to connect to application service endpoints (or application servers) through the operator network.

Although FIG. 10 illustrates an example dual steering architecture 1000, various changes may be made to FIG. 10. For example, architecture 1000 could include additional interfaces, routes, etc. according to particular needs.

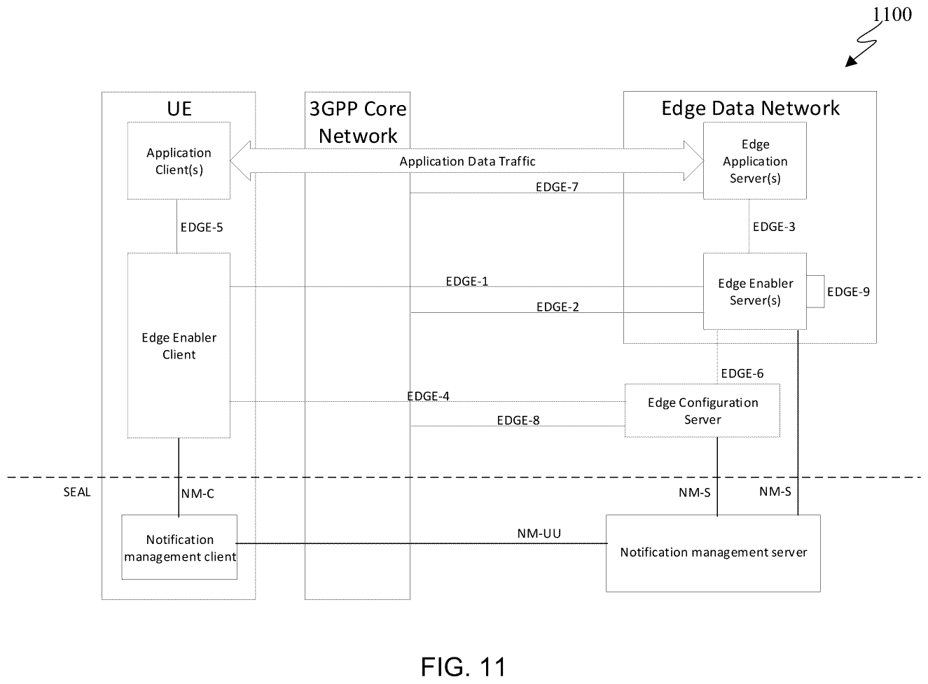

Wireless networks (e.g., 3GPP networks) may support application layer architectures, procedures and information flows to provide edge applications over the wireless networks. An example architecture for enabling edge applications is shown in FIG. 11.

FIG. 11 illustrates an example architecture 1100 for enabling edge applications according to embodiments of the present disclosure. The embodiment of enabling edge applications of FIG. 11 is for illustration only. Different embodiments of an architecture for enabling edge applications could be used without departing from the scope of this disclosure.

Architecture 1100 conforms with existing specifications for enabling edge applications in wireless networks.

Although FIG. 11 illustrates an example architecture 1100 for enabling edge applications, various changes may be made to FIG. 11. For example, architecture 1100 could include additional edge data networks, etc. according to particular needs.

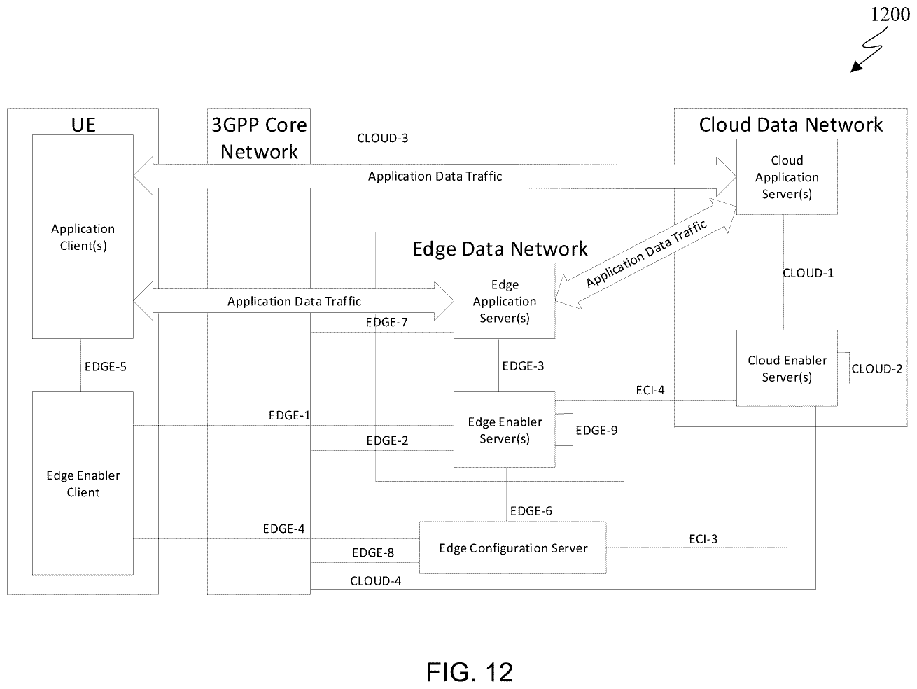

Wireless networks (e.g., 3GPP networks) may support application layer architectures, procedures and information flows for enabling cloud application with edge applications over the wireless networks. An example architecture for enabling cloud application with edge applications is shown in FIG. 12.

FIG. 12 illustrates an example architecture 1200 for enabling cloud application with edge applications according to embodiments of the present disclosure. The embodiment of enabling cloud application with edge applications of FIG. 12 is for illustration only. Different embodiments of an architecture for enabling cloud application with edge applications could be used without departing from the scope of this disclosure.

Architecture 1200 conforms with existing specifications for enabling cloud application with edge applications in wireless networks.

Although FIG. 12 illustrates an example architecture 1200 for enabling cloud application with edge applications, various changes may be made to FIG. 12. For example, architecture 1200 could include additional edge data networks, etc. according to particular needs.

When deploying application services, one issue that may be encountered is the problem of connectivity and routing between a local DN and a remote DN based on the deployment options chosen by the ECP, network operator, and the ASP. Some services may specify processing in the local DN followed by processing in the remote DN. However, because of routing considerations in provisioned deployments, application flows may be able to reach the remote DN from the local DN. Various embodiments of the present disclosure provide methods and apparatuses for operating media streaming services when follow up processing in a remote DN is not possible after processing in a local DN or vice versa.

In some embodiments, methods for edge service configuration with reachability requirements may facilitate discovery and selection of appropriate edge services for media streaming sessions.

In some embodiments, methods for application adaptation may reduce impact to service quality due to connectivity and reachability issues between edge application services and remote application services.

In some embodiments, methods may facilitate discovery and identification of edge application services when UE switches from the single access session to a multi-access session.

In some embodiments, methods may facilitate orchestration and synchronization of edge applications in multiple edge data networks when a UE switches from a single access session to a multi-access session.

When a higher level media service is being delivered over multiple access networks using dual steer architecture (as shown in FIG. 10) and access traffic switching steering and splitting architecture, existing specifications do not specify the impact to EAS discovery procedures and data models. When UE application flows are switching/steered/split to a different access network based on access traffic steering/switching/splitting rules (ATSSS) rules from the network to the UE based on existing procedures, the EAS allocated to the UE in the edge data network (EDN) may have to be replaced with a new EAS since the UE access for the media service has changed.

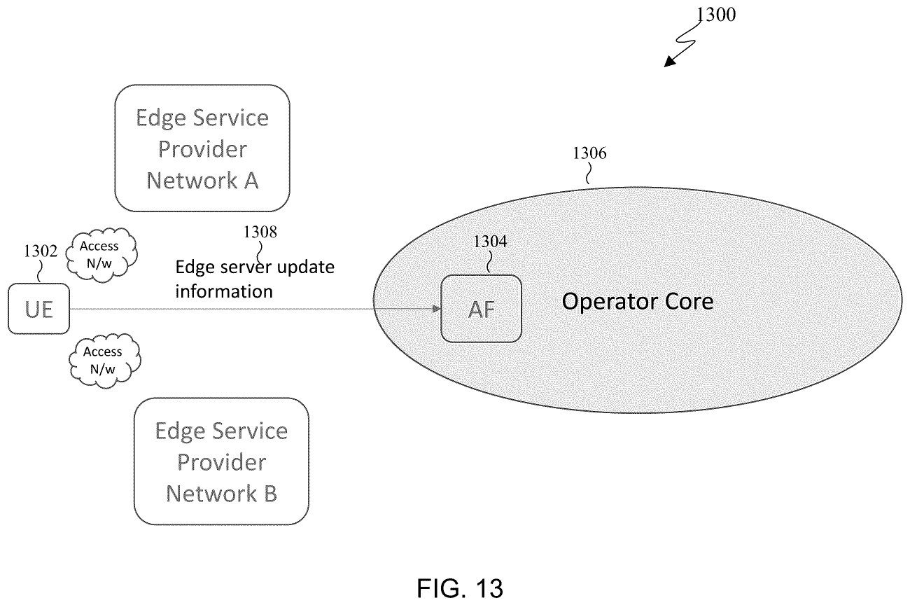

To facilitate discovery of appropriate EAS application servers to the UE in lieu of change of network access, the UE sends information to the apparatus entity in the network (e.g., an Application Function) that manages the edge application deployment for the corresponding media service as shown in FIG. 13.

FIG. 13 illustrates an example 1300 of transmission of edge server update information to enable selection of an appropriate edge service in lieu of network access changes according to embodiments of the present disclosure. The embodiment of edge service selection of FIG. 13 is for illustration only. Different embodiments of enabling selection of an appropriate edge service in lieu of network access changes could be used without departing from the scope of this disclosure.

In the example of FIG. 13, a UE 1302 sends information 1308 to AF 1304 which resides in an operator core network 1306. The information may include:
UE service continuity preference: Provides information about UE preference for service continuity during and post the change of access for media service. The following details may be included in this information:
   Re-discover EAS: Boolean flag to indicate whether the UE intends to have the network re-discovery edge application server due to change in network access
   EDN relocation information: Indicates whether the UE intends to have the edge application migrated to a new EDN or stay in the current EDN that was serving the application flows transferred over the old access network
EAS discovery filter information: Information provided by the UE to aid discovery of appropriate edge application server in the edge network. A list of EAS discovery filters is shown in Table 1 below. The following filters may be included in addition to the EAS discovery filters of Table 1 to support edge application enablement along with multi-access delivery:
   Old-access information: Information about old network access through which the application flows were transported before migration to a new access. This includes details such as type of access network, QoS measurements (e.g., latency, delay, throughput, bandwidth, packet loss rate etc. in both UL and DL direction)
   New-access information: Information about new network access to which the application flows to be steered/switched/split. This includes details such as type of access network, possible QoS measurements (e.g., latency, delay, throughput, bandwidth, packet loss rate etc. in both UL and DL direction)

TABLE 1
EAS Discovery Filters

| Information Element | Description |
|---|---|
| List of Application Client (AC) characteristics | Describes the ACs for which a matching EAS |
| | is requested. |
| AC profile | AC profile containing parameters used to |
| | determine matching EAS. |
| Application group profile | Application group profile associated with the |
| | AC Profile |
| List of EAS characteristics | Describes the characteristic of requested |
| | EASs. |
| EASID | Identifier of the requested EAS. |
| Application Group ID | Application group identifier |
| EAS content synchronization support | Indicates if the EAS content synchronization |
| | support is required or not. |
| Bundle ID | A list of EASIDs or a bundle ID |
| List of EASIDs | A list of EASIDs specific to a particular EAS |
| | bundle. |
| Bundle type | Type of the EAS bundle |
| EAS bundle requirements | Requirements associated with the EAS bundle |
| EAS provider identifier | Identifier of the required EAS provider |
| EAS type | The category or type of required EAS (e.g., |
| | V2X, UAV, application enabler) |
| EAS schedule | Requested availability schedule of the EAS |
| | (e.g., time windows) |
| EAS Geographical Service Area | Location(s) (e.g., geographical area, route) |
| | where the EAS service should be available. |
| EAS Topological Service Area | Topological area (e.g., cell ID, TAI) for |
| | which the EAS service should be available. |
| Service continuity support | Indicates if the service continuity support is |
| | required or not. |
| Service permission level | Requested level of service permissions e.g., |
| | trial, gold-class |
| Service feature(s) | Requested service features e.g., single vs. |
| | multi-player gaming service |

Although FIG. 13 illustrates an example 1300 of transmission of edge server update information to enable selection of an appropriate edge service in lieu of network access changes, various changes may be made to FIG. 13. For example, AF 1304 could represent a different apparatus, etc. according to particular needs.

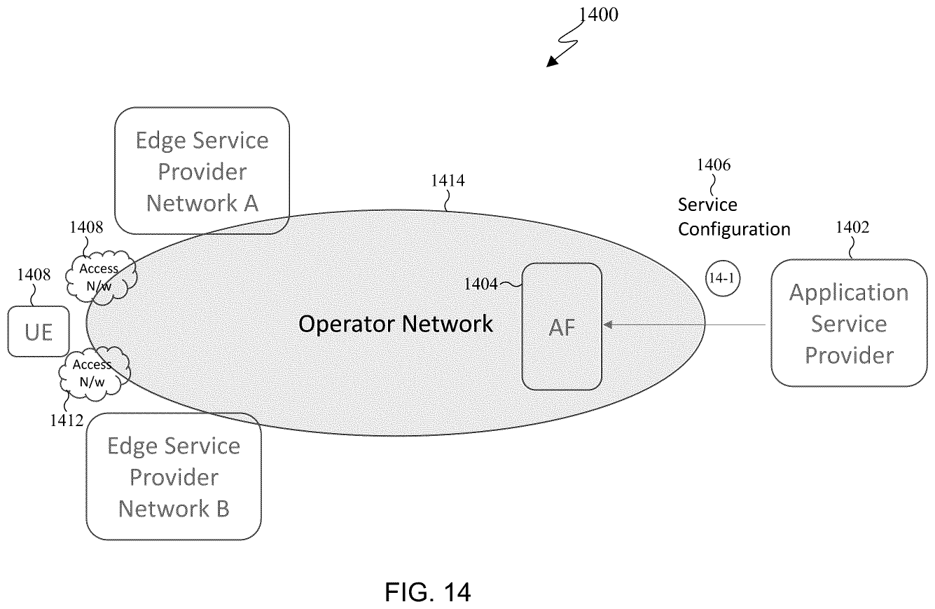

When UE application flows are steered/switched/split from one access to another access, it is possible that the UE application flows may have better alternatives for edge application services than when the flows go through the original access. Alternatively, the network operator and/or the application service provider may provide alternatives to current edge application services if the UE application flows are steered/switched/split. To facilitate this, the application service provider may request provisioning of edge application services with different processing capabilities for different access networks, and the network operator, upon receiving such a request from the application provider, provisions edge application services with different capabilities for different access networks that the UE may use, or the UE application flows may be steered/switched towards or split to as shown in FIG. 14.

FIG. 14 illustrates an example 1400 of service configuration of edge services per access according to embodiments of the present disclosure. The embodiment of service configuration of edge services per access of FIG. 14 is for illustration only. Different embodiments of service configuration of edge services per access could be used without departing from the scope of this disclosure.

In the example of FIG. 14, the application service provider performs service configuration (step 14-1) at a network apparatus entity (i.e., AF 1404) by transmitting service configuration information 1406 to AF 1404. The service configuration information may include the details shown in Table 2.

TABLE 2
Service Configuration Information

| Information Element | Description |
|---|---|
| Setup_differential_edge_services | Boolean variable to indicate that the application service |
| | provider intends that the network operator provide edge |
| | application services with differential quality and performance |
| | for different access networks different UEs may use. |
| Access network_service_ | Map/list of access network service descriptor. Each entry in |
| descriptor List/Map | the map is of the form <key, value> pair where key represents |
| | the access network Id, and value is the service descriptor for |
| | the access network with the given access network Id. The |
| | service descriptor includes the following information: |
| | Service Id: Identifier of service |
| | service level: Maximum associated service level on the |
| | given access network. For example, if there are three |
| | service levels (“platinum”, “gold”, and “silver”) in the |
| | decreasing order of performance/class, the application |
| | service provider may configure a maximum service |
| | level of “gold” on one network access, and “platinum” |
| | for a different access network |
| | service features: Number or type of service e.g., |
| | single-player game vs multi-player game. The |
| | application service provider may request provisioning |
| | of edge application services that provides only the |
| | single-player gaming service on one network access, |
| | and multi-player gaming service on a different access |
| | network |
| | Service Schedule: Represents the time when the |
| | service is up on the given access network. The |
| | application service provider may request provisioning |
| | of edge service on one access network for a short |
| | period of time, while for a longer duration on a |
| | different access network. |
| | Service continuity level: Level of service continuity |
| | when the application flows from the given access |
| | network are steered/switched/split to other access |
| | network. This information may be in the form of a |
| | list/map where each member of the list/map provides |
| | the service continuity levels when the UE flows are |
| | steered/switched/split from given access network to |
| | another access among a list of potential access |
| | networks. |

When AF 1404 receives the above service configuration information from the application service provider 1402, the AF1404 facilitates setting up edge services with different capabilities for application flows from UEs (e.g., UE 1408) over specific access networks (e.g., access networks 1410 and 1412). With this procedure, the application service provider 1402 and/or the network operator of operator network 1414 may prioritize delivery of higher level services over specific access networks.

Although FIG. 14 illustrates an example 1400 of service configuration of edge services per access, various changes may be made to FIG. 14. For example, FIG. 14 could include additional access networks and/or additional edge data networks, etc. according to particular needs.

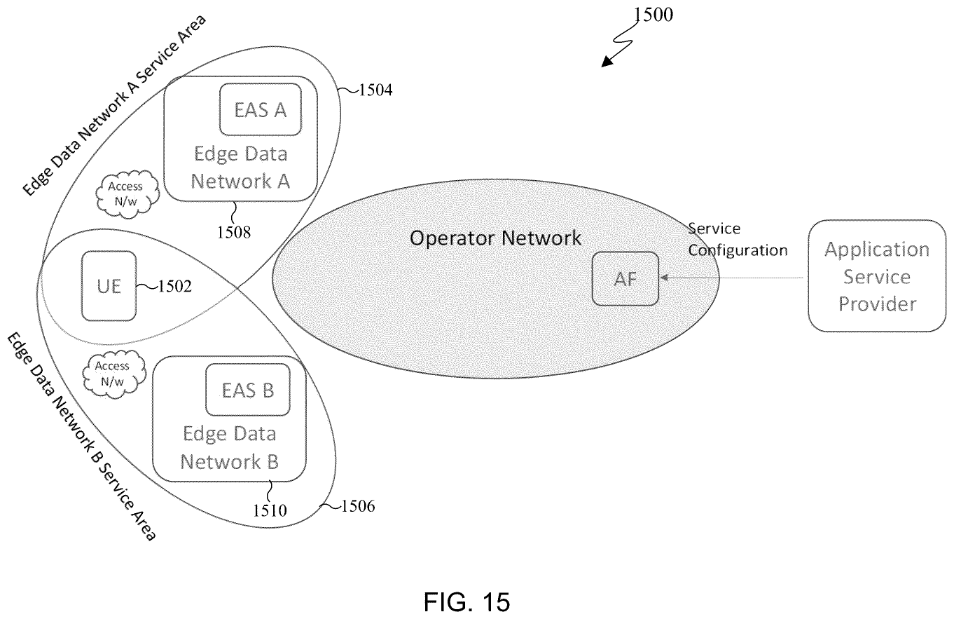

In some circumstances, it is possible that a UE is in a location that overlaps the service areas of two different edge data networks (EDNs). In some cases, one or more of the two EDNs could be 3GPP specified local area data networks (LADNs). The service area of each EDN/LADN could be a small area, an area as large as the entire PLMN, and any size area in between. When the UE is in a location in which the service areas of two or more EDNs/LADNs overlap, then the UE has access to edge application servers in all of the overlapping EDNs/LADNs as shown in FIG. 15.

FIG. 15 illustrates an example 1500 of a UE in service areas of two different EDNs/LADNs according to embodiments of the present disclosure. The embodiment of a UE in service areas of two different EDNs/LADNs of FIG. 15 is for illustration only. Different embodiments of a UE in service areas of two different EDNs/LADNs could be used without departing from the scope of this disclosure.

As shown in FIG. 15, the UE 1502 is in a location where the service areas 1504 and 1506 of two different EDNs 1508 and 1510 overlap. Therefore, there is a possibility that the UE 1502 may be able to use the edge services belonging to each of these two EDNs/LADNs. While the example of FIG. 15 only depicts two EDNs 1508 and 1510, UE 1502 may also be in a location where service areas of additional EDNs/LADNs (not shown) overlap with the service areas of EDNs 1508 and 1510. In this scenario, UE 1502 may also be able to use the edge services belonging to the additional EDNs/LADNs.

Although FIG. 15 illustrates an example 1500 of a UE in service areas of two different EDNs/LADNs, various changes may be made to FIG. 15. For example, FIG. 15 could include additional EDNs, etc. according to particular needs.

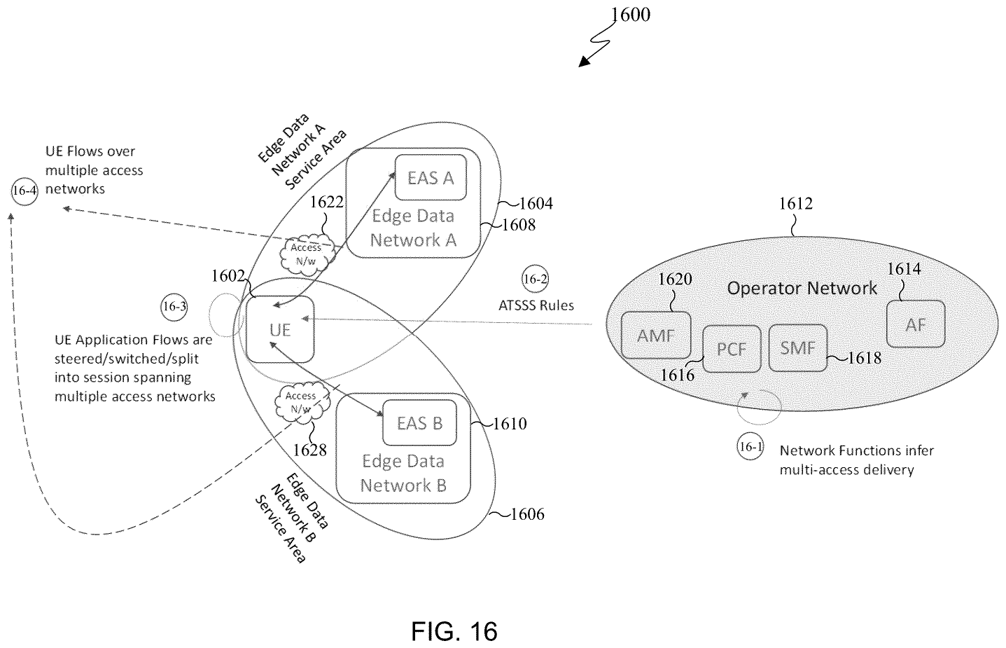

When a UE has access to multiple EDNs, it is possible that the UE may use the services in both the EDNs because of multi-access delivery as shown in FIG. 16.

FIG. 16 illustrates an example 1600 of a multi-access delivery when a UE in the service areas of two different EDNs/LADNs according to embodiments of the present disclosure. The embodiment of multi-access delivery of FIG. 16 is for illustration only. Different embodiments of multi-access delivery when a UE in the service areas of two different EDNs/LADNs could be used without departing from the scope of this disclosure.

In the example of FIG. 16, UE 1602 is in a location where the service areas 1604 and 1606 of two different EDNs 1608 and 1610 overlap. Therefore, UE 1602 may be able to use edge services in both of the EDNs 1608 and 1610, and UE 1602 and network 1612 may potentially activate multi-access delivery. For UE 1602 to use edge services in both the EDNs 1608 and 1610, the following steps are performed:

At step 16-1, network function entities such as the AF 1614, PCF 1616, SMF 1618, AMF 1620, etc. infer that the UE 1602 benefits from multi-access delivery. The network functions then build ATSSS rules.

At step 16-2, the network entities forward the ATSSS rules to UE 1602. The ATSSS rules have details about how the application traffic is to be steered/switched/split into multiple access networks.

At step 16-3, when UE 1602 receives ATSSS rules, the application traffic is steered/switched/split to multiple access networks (e.g., access networks 1622 and 1628).

At step 16-4, the application flows are then transmitted/received by UE 1602 over the multiple access networks.

Although FIG. 16 illustrates an example 1600 of a multi-access delivery when a UE in the service areas of two different EDNs/LADNs, various changes may be made to FIG. 16. For example, FIG. 16 could include additional EDNs, etc. according to particular needs.

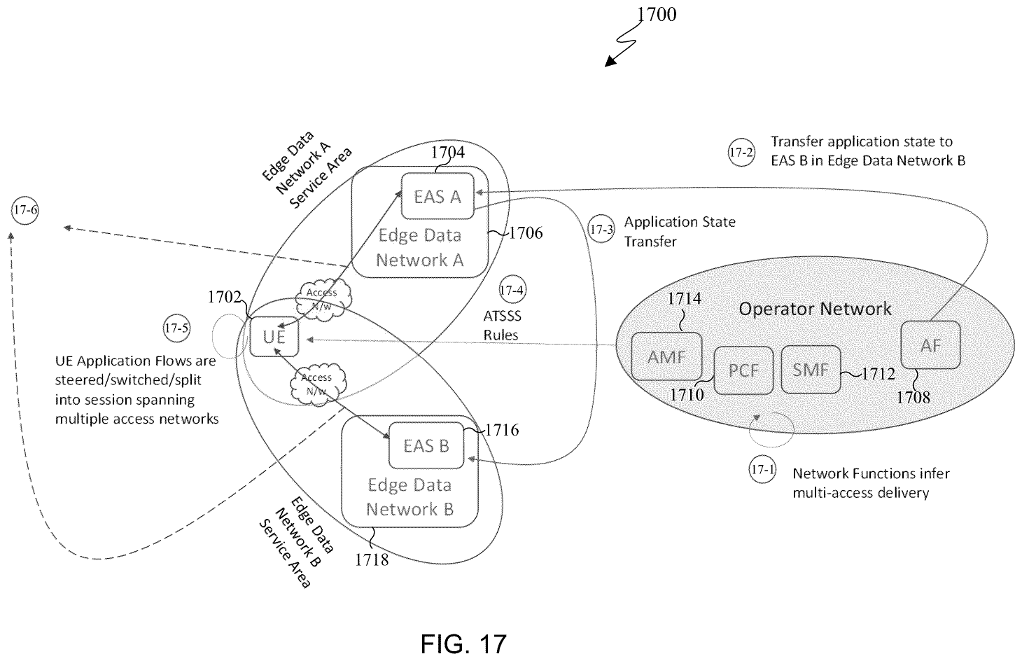

When the UE application flows are sent and received over multiple access networks as described regarding FIG. 16, the application state may be copied from one edge application server in an EDN to a different edge application server in a different EDN as shown in FIG. 17.

FIG. 17 illustrates an example 1700 of an application state transfer to enable seamless multi-access delivery according to embodiments of the present disclosure. The embodiment of an application state transfer of FIG. 17 is for illustration only. Different embodiments of an application state transfer to enable seamless multi-access delivery could be used without departing from the scope of this disclosure.

In the example of FIG. 17, steps are shown for copying of application states to enable a seamless service experience when a UE is using multi-access delivery and has access to multiple EDNs. The example of FIG. 17 presumes that UE 1702 was primarily using EAS 1704 (EAS A) in edge data network 1706 (edge data network A) before network entities such as the AF 1708, PCF 1710, SMF 1712, AMF 1714, etc. decide to switch the UE session from a single access PDU session to a multi-access PD session spanning multiple access networks.

At step 17-1, the network entities infer a switch to multi-access delivery for the service, similar as described regarding step 16-1 of FIG. 16.

At step 17-2 the network entity apparatus (e.g., AF 1708) informs EAS 1704 (EAS A) in edge data network 1706 (edge network A) to transfer or copy the application state to EAS 1716 (EAS B) in edge network 1718 (edge network B).

At step 17-3, EAS 1704 (EAS A) in edge data network 1706 (edge network A) copies or transfers the application state to EAS 1716 (EAS B) in edge network 1718 (edge network B).

At step 17-4, ATSSS rules for traffic steering/switching/splitting are provided to UE 1702, similar as described regarding step 16-2 of FIG. 16.

At step 17-5, UE application flows are steered/switched/split to multiple access networks similar as described regarding step 16-3 of FIG. 16.

At step 17-6, The application flows are then transmitted/received over multiple access networks similar as described regarding step 16-4 of FIG. 16. Because of the ATSSS rules, the application flows may be entirely switched to other access and therefore reach EAS 1716 (EAS B) in edge network 1718 (edge network B). Alternatively, because of the ATSSS rules, the application traffic may be split, and some portion of the application traffic goes through one access network reaching EAS 1704 (EAS A) in edge data network 1706 (edge network A) and while the remaining application traffic goes through another access network and reaches EAS 1716 (EAS B) in edge network 1718 (edge network B). For either of these cases, since the application state was copied/transferred from EAS 1704 (EAS A) in edge data network 1706 (edge network A) to EAS 1716 (EAS B) in edge network 1718 (edge network B), all the UE application flows continue to receive required processing in the two edge data networks.

The procedure described above for migrating to a multi-access session and resulting in copying/transfer of application state may be triggered because of following reasons:
Application metrics such as packet loss, packet error rate, jitter etc. show that the UE 1702 is not meeting the service expectations with a single access session.
Application metrics show that the UE 1702 is not meeting the service expectations with a single access session.
Application metrics related to dynamic policy show that the UE 1702 is not meeting the service expectations with a single access session, or, when UE 1702 requests the allowed dynamic policy for the application flows by the application service provider, but the network is unable to provide the requested QoS for the identified application flows over the existing access network.

Although FIG. 17 illustrates an example 1700 of an application state transfer to enable seamless multi-access delivery, various changes may be made to FIG. 17. For example, FIG. 17 could include additional EDNs, etc. according to particular needs.

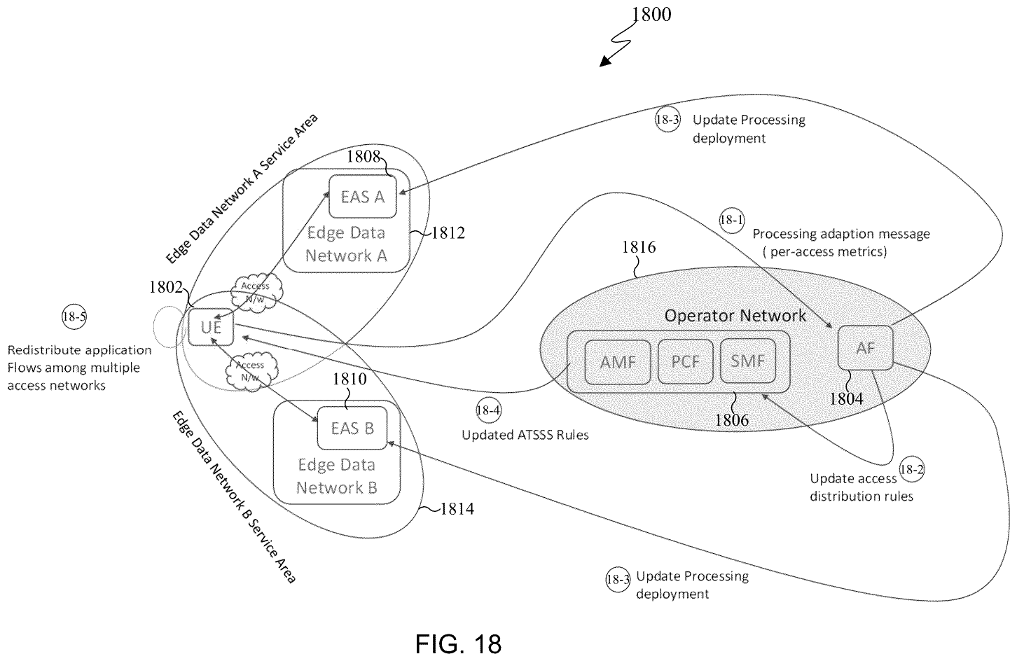

In the processes described with respect to FIG. 16 and FIG. 17 the network apparatus and the network control entities infer that a UE may benefit from multi-access delivery when the UE is in a location where service areas of two or more edge data networks overlap. It is possible that once the multi-access delivery is enabled and multiple edge application servers are used, the UE, over a period of time, may not have optimal service performance. To facilitate improvement of service experience in this case, a processing adaptation procedure can be performed as shown in the FIG. 18.

FIG. 18 illustrates an example 1800 of processing adaptation in multiple edge data networks with multi-access delivery according to embodiments of the present disclosure. The embodiment of processing adaptation of FIG. 18 is for illustration only. Different embodiments of processing adaptation in multiple edge data networks with multi-access delivery could be used without departing from the scope of this disclosure.

In the example of FIG. 18, steps are shown for processing adaptation in multiple edge data networks with multi-access delivery. The example of FIG. 18 presumes that a multi-access session spanning multiple access networks is already setup and the UE application flows are sent to/received from multiple edge application servers in different edge data networks similar as described regarding FIG. 16 and FIG. 17.

At step 18-1, UE 1802 performs a service measurement, and finds that the service is not optimal. UE 1802 sends a processing adaptation message to the network apparatus entity (application function AF 1804). The UE 1802 may include per-access measurements to convey performance of application flows in different access networks.

At step 18-2, the AF 1804, using the per-access measurements may infer that the processing deployment of the service needs to be adjusted so UE 1802 may have optimal service performance. The AF 1804 re-computes the amount and type of UE application flows to be steered/split/switched/distributed across multiple access networks. Based on the computation, AF 1804 informs the network control entities 1806 to update the access network distribution and composition rules.

At step 18-3, AF 1804 communicates with the edge application servers 1808 and 1810 in different edge data networks 1812 and 1814 to adjust processing deployment in anticipation of upcoming changes in application flow capacity. For example, the AF 1804 may inform one edge application server in one edge data network to increase its capacity for upcoming traffic increase, and may inform the edge application server in another edge data network to lower the processing capacity. Upon receiving this message from the application function, the edge servers 1808 and 1810 in different edge data networks 1812 and 1814 update their processing capacities and capabilities.

At step 18-4, based on information from AF 1804 about updating access distribution and composition rules, the network control entities 1806 may update the ATSSS rules and forward them to UE 1802.

At step 18-5, based on updated ATSSS rules from the network 1816, the UE 1802 may re-distribute the application traffic among one or more access networks. With this adjustment, more application flow packets may reach the edge application server whose processing capacities and capabilities were increased, and application flow packets to other edge application servers may be reduced as their capacities and capabilities were lowered.

Using the procedure of FIG. 18, the AF 1804 may frequently check the performance of service to adjust processing deployment in different edge application servers in different edge data networks.

Possible mechanisms that the AF 1804 may undertake as part of the processing adaption functionalities include:
Changing the amount and type of application flow traffic: AF 1804 may request network entities 1806 to update the ATSSS rules so that a different set of application flows may be routed through the EAS servers so the amount of processing happening at each EAS server in different EDN is different from earlier.
Pausing/stopping application traffic to one or more EASs for a given time period: AF 1804 may request network entities 1806 to update the ATSSS rules so that one or more EAS servers (e.g., worse performing EAS servers) stop receiving application traffic from/to the UE 1802 for a given time period. For this case, the application flows originally going through these EDNs are routed to a different EAS in a different EDN. The application service provider may provide information (e.g., which flows to be routed over which EDNs) as part of the service configuration described regarding FIG. 14 and FIG. 15.
Pausing/stopping application traffic over one or more access networks: AF 1804 may request network entities 1806 to update the ATSSS rules so that one or more access networks may be avoided for a period of time. The AF 1804 may configure this information with the assistance of an application service provider provided configuration
Discovering a new EAS in a given EDN: AF 1804 may inform the application function of one or more EDNs to discover a new edge application instance to serve the application flow traffic of the UE 1802.

Although FIG. 18 illustrates an example 1800 of processing adaptation in multiple edge data networks with multi-access delivery, various changes may be made to FIG. 18. For example, FIG. 18 could include additional EDNs, etc. according to particular needs.

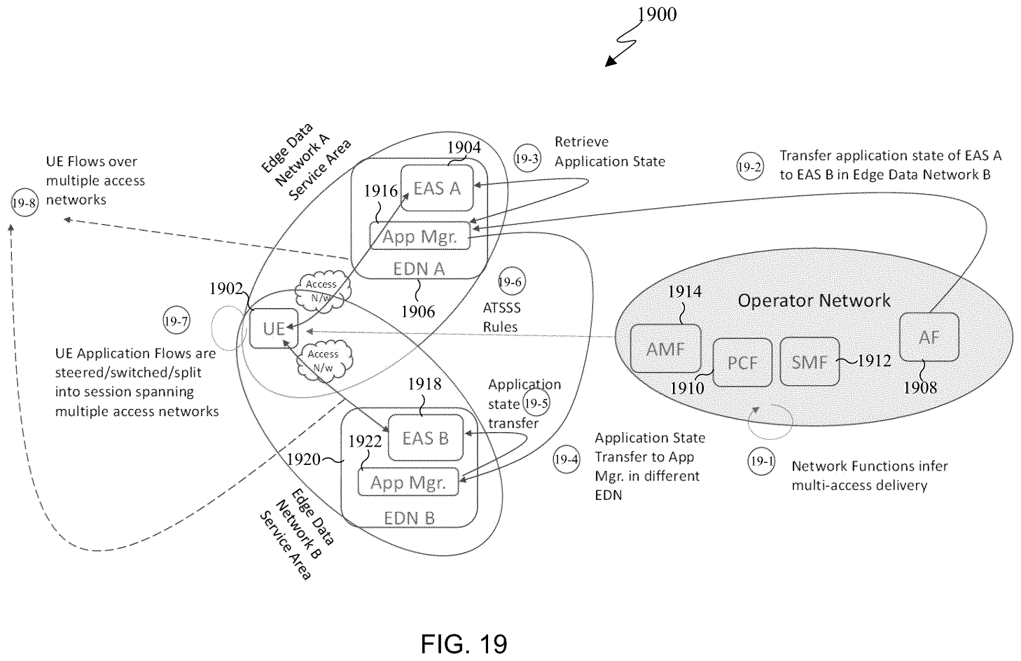

In the example method shown in FIG. 17, an edge application server is informed by the network apparatus entity (Application Function) to copy or transfer an application state to a different edge application server in a different edge data network. FIG. 19 shows an alternative method where instead of the edge application server being responsible for transferring the application state, the network apparatus entity may request the edge application manager (e.g., an edge enable server [EES]) to copy or transfer the application state.

FIG. 19 illustrates an example 1900 of application state transfer using application managers in edge data networks according to embodiments of the present disclosure. The embodiment of application state transfer of FIG. 19 is for illustration only. Different embodiments of application state transfer using application managers in edge data networks could be used without departing from the scope of this disclosure.

In the example of FIG. 19, steps are shown for copying of application states to enable a seamless service experience when a UE is using multi-access delivery and has access to multiple EDNs. The example of FIG. 19 presumes that UE 1902 was primarily using EAS 1904 (EAS A) in edge data network 1906 (edge data network A) before network entities such as the AF 1908, PCF 1910, SMF 1912, AMF 1914, etc. decide to switch the UE session from a single access PDU session to a multi-access PDU session spanning multiple access networks.

At step 19-1, the network entities infer a switch to multi-access delivery for the service, similar as described regarding step 16-1 of FIG. 16 or step 17-1 of FIG. 17.

At step 19-2, the network apparatus entity (e.g., the AF 1908) informs the application manager 1916 in the edge data network 1906 (edge data network A) to transfer or copy application state of EAS 1904 (EAS A) in edge data network 1906 (edge data network A) to EAS 1918 (EAS B) in edge data network 1920 (edge data network B).

At step 19-3, The application manager 1916 retrieves the application state from EAS 1904 (EAS A).

At step 19-4, the application manager 1916 in edge data network 1906 (edge data network A) copies or transfers the application state to application manager 1922 in edge data network 1920 (edge data network B).

At step 19-5, the application manager 1922 in edge data network 1920 (edge data network B) discovers an appropriate EAS (EAS 1918 [EAS B]) a then copies the application state to EAS 1918 (EAS B).

At step 19-6, ATSSS rules for traffic steering/switching/splitting are provided to UE 1902, similar as described regarding step 16-2 of FIG. 16 or step 17-4 of FIG. 17.

At step 19-7, UE application flows are steered/switched/split to multiple access networks as described regarding step 16-3 of FIG. 16 or step 17-5 of FIG. 17.

At step 19-8, the application flows are then transmitted/received over multiple access networks similar as described regarding step 16-4 of FIG. 16 or step 17-6 of FIG. 17. Because of the ATSSS rules, the application flows may be entirely switched to other access and therefore reach EAS 1918 (EAS B) in edge data network 1920 (edge data network B). Alternatively, because of the ATSSS rules, the application traffic may be been split, and some portion of the application traffic goes through one access network reaching EAS 1904 (EAS A) in edge data network 1906 (edge data network A) and remaining application traffic goes through another access network and reaches EAS 1918 (EAS B) in edge data network 1920 (edge data network B). For either of these cases, since the application state was copied/transferred from EAS A in Edge Data Network A to EAS 1918 (EAS B) in edge data network 1920 (edge data network B), all the UE application flows continue to receive required processing in the two edge data networks.

Although FIG. 19 illustrates an example 1900 of application state transfer using application managers in edge data networks, various changes may be made to FIG. 19. For example, FIG. 19 could include additional EDNs, etc. according to particular needs.

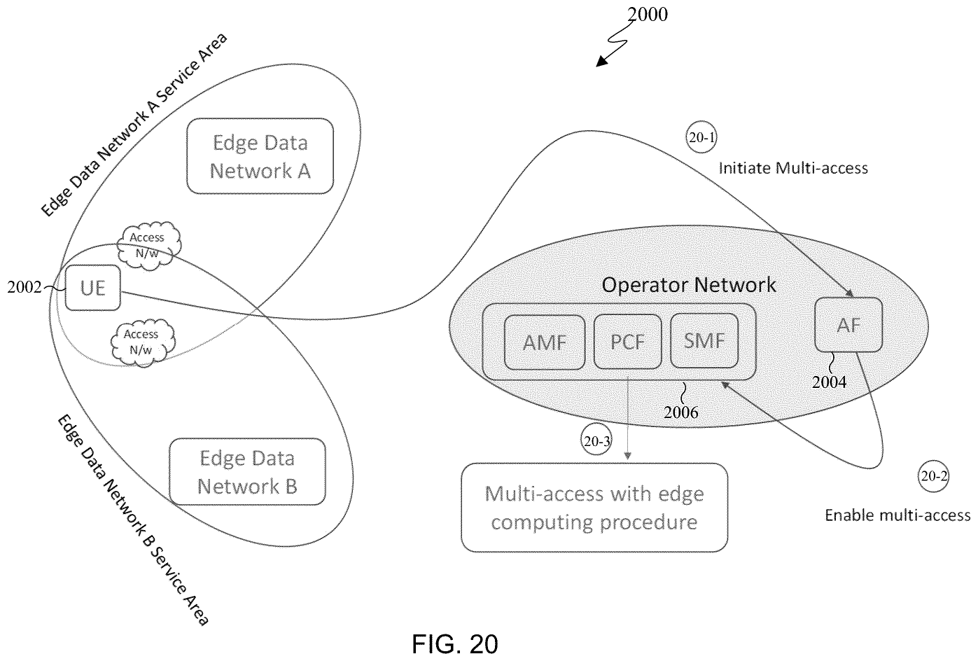

In the example method shown in FIG. 18, a network initiated application state transfer is performed when network entities in a mobile core network recognize the need or use of multi-access delivery. In the method of FIG. 18, either the UE or the network may take the responsibility of initiating the application state transfer. FIG. 20 shows an alternative method where the UE, using an edge application service, may request that it intends to use multiple access networks for a service session.

FIG. 20 illustrates an example UE initiated procedure 2000 for multi-access with access to multiple edge data networks according to embodiments of the present disclosure. The embodiment multi-access with access to multiple edge data networks of FIG. 20 is for illustration only. Different embodiments of a UE initiated procedure for multi-access with access to multiple edge data networks could be used without departing from the scope of this disclosure.

In the example of FIG. 20, steps are shown for UE initiated multi-access delivery when the UE has access to multiple edge data networks through different access networks.

At step 20-1, either before start of a session, or during the session, UE 2002 determines it is interested performing a multi-access session. UE 2002 conveys this information to the network apparatus entity (AF 2004).

At step 20-2, AF 2004 forwards this interest to network control entities 2006.

At step 20-3, the network entities 2006 perform a procedure to enable multi-access delivery and perform application state transfer, similar as described regarding FIG. 18. When performing this procedure, the network entities 2006 may check the location of UE 2002 and find that it is in a location where the service areas of two different EDNs overlap, and therefore UE 2002 has the ability to connect to multiple edge services in different edge data networks as described herein.

Although FIG. 20 illustrates an example UE initiated procedure 2000 for multi-access with access to multiple edge data networks, various changes may be made to FIG. 20. For example, FIG. 20 could include additional EDNs, etc. according to particular needs.

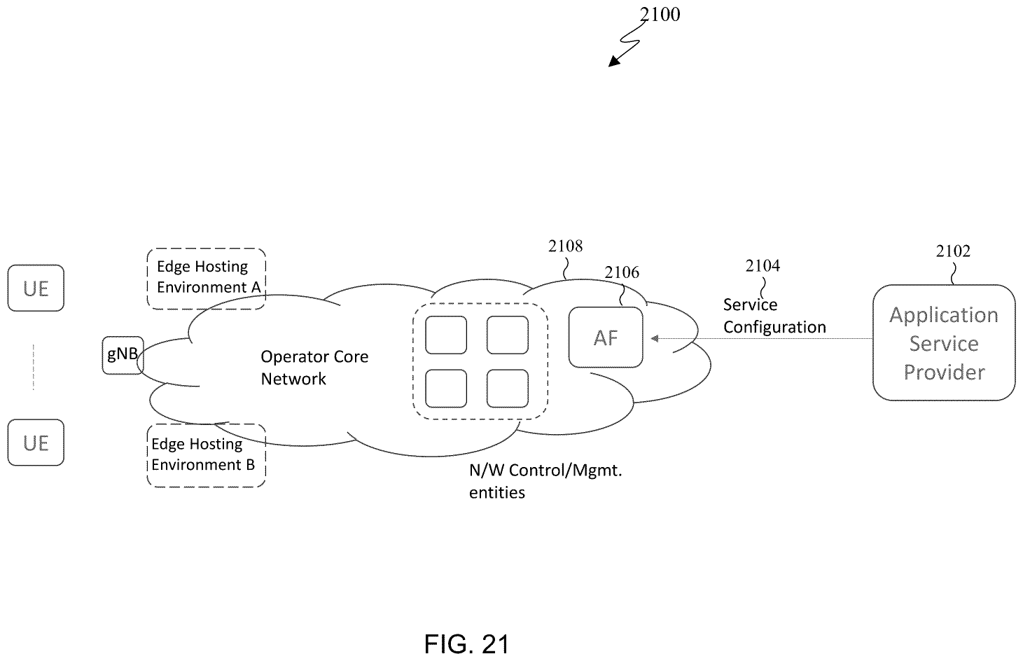

In some embodiments, an ASP may negotiate with a network operator for service deployment options as shown in FIG. 21.

FIG. 21 illustrates an example 2100 of application service provider configuration of service according to embodiments of the present disclosure. The embodiment of application service provider configuration of service of FIG. 21 is for illustration only. Different embodiments of application service provider configuration of service could be used without departing from the scope of this disclosure.

In the example of FIG. 21, an ASP 2102 sends a service configuration 2104 to AF 2106 in operator network 2108 over an M1 provisioning interface. Existing specification for the M1 provisioning interface provide policy requirements and QoS/QoE requirements. However, the requirements in the existing specifications mainly focus on QoS/QoE in the mobile operator network. Presently, there is not requirement in existing specifications for supporting routing between a local DN and remote DN, and the end-to-end QoS/QoE between the UE, local DN entities (AF, AS), and remote DN entities (remote AF and remote AS functions). In various embodiments of the present disclosure, the M1 provisioning interface may include the enhancements shown in Table 3.

TABLE 3
M1 Provisioning Interface Enhancements

| Information Element | Description |
|---|---|
| end-to-end requirements | These requirements describe end-to-end QoS/QoE |
| | requirements from a UE to a Local DN and to a Remote |
| | DN |
| | The format of the QoS/QoE requirements is similar to |
| | existing specifications. However, these values represent |
| | end-to-end requirements while existing parameters |
| | represent the QoS/QoE requirements from either UE to |
| | Local DN or UE to Remote DN. |
| remote_DN_connectivity_required | For workloads to be set up in Local DN or Edge DN, if |
| | this variable is set to True, then the application service |
| | provider requires that connectivity exists between the |
| | local DN and the remote DN. |
| | If this variable is set to False, the application service |
| | provider does not require that connectivity exists |
| | between the Local DN and the remote DN. This is for the |
| | cases that all processing is performed in the Local DN. |
| | When this configuration is received by the AF, the AF |
| | communicates with other network functions in the |
| | mobile operator network to provision connectivity |
| | between the local DN and remote DN. |
| edge_networks_priority_map | Map of edge networks or Local DNs where the |
| | edge/local processing may be deployed. The map |
| | provides a mapping between the edge network and the |
| | priority where the edge resources have to be setup. |
| | When this option is requested by the ASP, the |
| | provisioning AF checks to see if the |
| | remote_DN_connectivity_required flag described above |
| | is enabled. If it is enabled, then the AF chooses the |
| | highest priority edge network in this map which has |
| | connectivity enabled between the edge network and |
| | Remote DN. |

Although FIG. 21 illustrates an example 2100 of application service provider configuration, various changes may be made to FIG. 21. For example, FIG. 21 could include an alternate service provisioning interface or additional edge hosting environments, etc. according to particular needs.

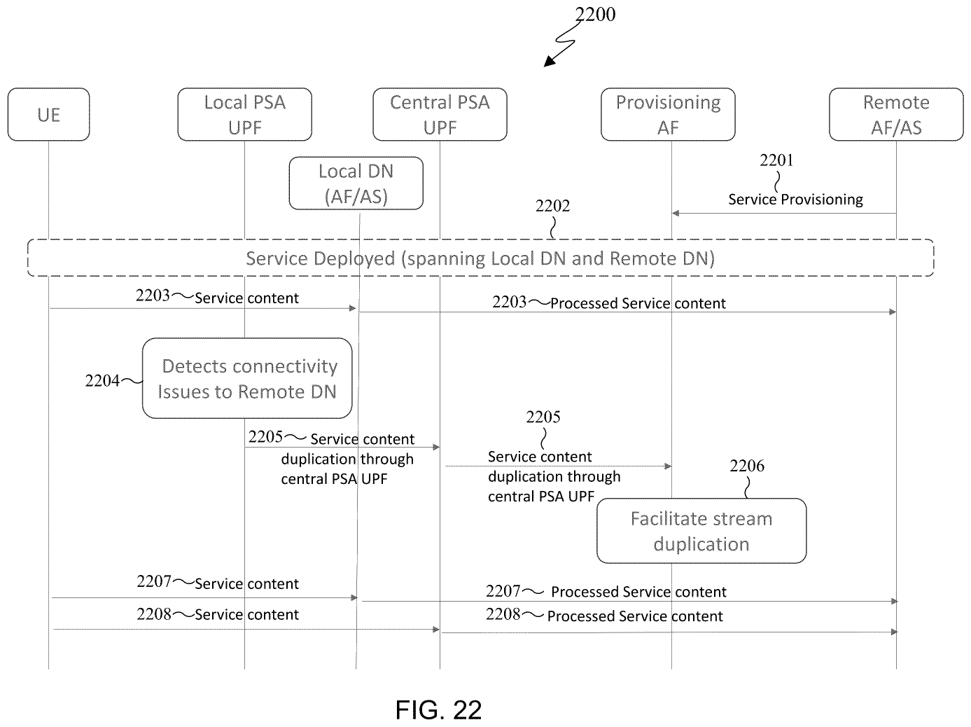

FIG. 22 illustrates an example method 2200 for service content duplication through a local UPF and central UPF according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a method for service content duplication through a local UPF and central UPF could be used without departing from the scope of this disclosure.

In the example of FIG. 22, method 2200 is a procedure for stream duplication (service content duplication) when there are connectivity issues between a Local DN and a Remote DN. In method 2200 the ASP performs the service configuration with required end-to-end QoS/QoE requirements, and the network adapts to changing network conditions to facilitate service content duplication to avoid failing of processing at both the Local DN and Remote DNs.

Method 2200 begins at step 2201. At step 2201, ASP performs service provisioning and configuration using an M1 interface. The service provisioning and configuration information are enhanced with the information of Table 3.

At step 2202, the provisioning AF facilitates the setup of service. The provisioning AF makes sure that the local DN AF/AS are informed of the end-to-end QoS requirements for the service to run.

At step 2203, the service content flows through between the UE, local DN AF/AS, and remote DN AF/AS. In some embodiments, the service content may optionally also flow through between the UE and remote DN AF/AS if no edge computing support was sought by the ASP.

At step 2204, the local site PSA UPF detects connectivity issues with the remote DN. For example, the local UPF may be informed by the local DN AF/AS that the packet latencies/jitter are higher or throughput is lower etc. (i.e., the local DN AF/AS informs the local PSA UPF that the end-to-end QoS/QoE requirements are unable to the followed).

At step 2205, the local PSA UPF requests the central PSA UPF for service content duplication as the local PSA UPF is unable to guarantee end-to-end QoS/QoE. The central PSA UPF notifies this behavior to the provisioning AF.

At step 2206, the provisioning AF facilitates the service content duplication by communicating with other network functions in the mobile operator network.

At step 2207, service content is transmitted in between the UE, local DN AF/AS, and Remote DN AF/AS.

At step 2208, service content is transmitted directly in between the UE and remote DN AF/AS through the central PSA UPF.

Although FIG. 22 illustrates one example method 2200 for service content duplication through a local UPF and central UPF, various changes may be made to FIG. 22. For example, while shown as a series of steps, various steps in FIG. 22 could overlap, occur in parallel, occur in a different order, occur any number of times, be omitted, or replaced by other steps.

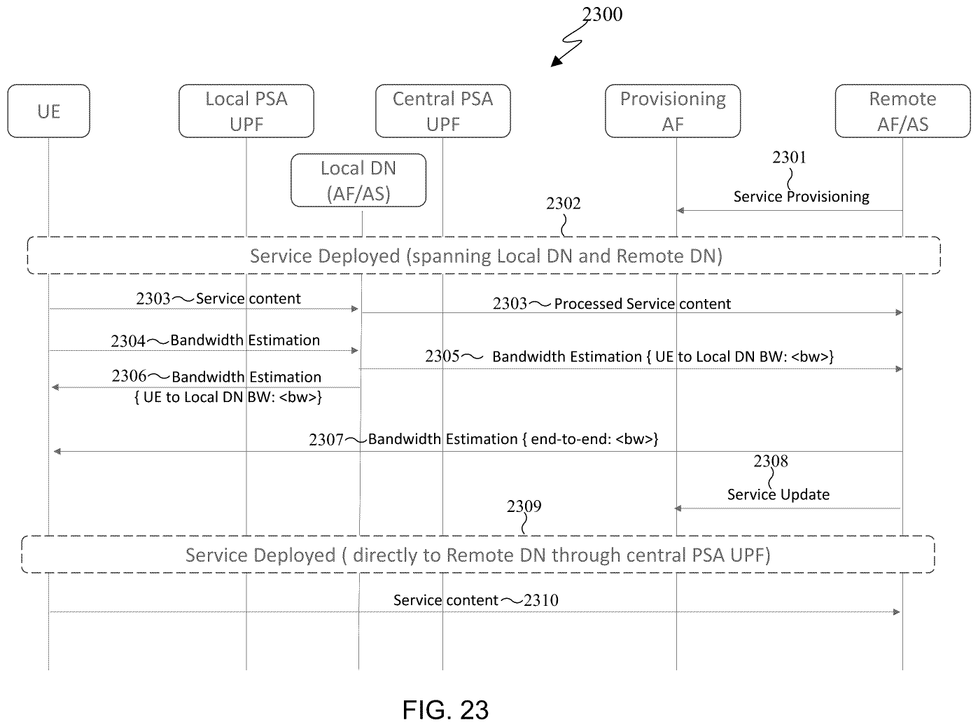

FIG. 23 illustrates an example method 2300 for a service update to avoid using a local DN because of bandwidth estimation according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for a service update to avoid using a local DN because of bandwidth estimation could be used without departing from the scope of this disclosure.

In the example of FIG. 23, method 2300 is a procedure based on bandwidth estimation to identify connectivity issues between a Local DN and Remote DN, and perform a service update to stop using the Local DN if necessary. In method 2300 the ASP performs the service configuration, and based on messaging from the UE, Local DN, and Remote DN, a service update is performed to avoid using the Local DN.

Method 2300 begins at step 2301. At step 2301, the ASP performs service provisioning and configuration using an M1 interface.

At step 2302, the provisioning AF facilitates the setup of service.

At step 2303, the service content flows through between the UE, local DN AF/AS, and remote DN AF/AS. In some embodiments, the service content may also optionally flow through between the UE and remote DN AF/AS if no edge computing support was sought by the ASP.

At step 2304, the UE makes a request for bandwidth estimation using network assistance procedures.

At step 2305, the local DN AF/AS forwards the bandwidth estimation request to the remote DN AF/AS. The local DN AF/AS, based on network measurements, estimates the available bandwidth between the UE and local DN AF/AS and provides this information to the Remote DN AF/AS in the forwarded bandwidth estimation request.

At step 2306, the Local DN AF/AS also provides the above information to the UE.

At step 2307, upon receiving the bandwidth estimation request from the local DN AF/AS, the remote DN AF/AS based on network measurements, estimates the available bandwidth between the UE, local DN AF/AS, and remote DN AF/AS, and provides this information to the UE. In some embodiments, the remote DN AF/AS may optionally provide end-to-end bandwidth estimation between the UE, local DN AF/AS, and remote DN AF/AS to the UE. Based on step 2307 and previous step 2306, the UE is informed of the available bandwidth between the UE, local DN AF/AS, and remote DN AF/AS.

At step 2308, the remote DN AF/AS may sense an issue due to the bandwidth estimation, and may provide a service update configuration to the provisioning AF. The service update provisioning information may indicate that the provisioning AF is to terminate the session through the local DN AF/AS and instead only have a direct transfer from the UE to the remote DN AF/AS.

At step 2309, the provisioning AF communicates with other network entities in the operator network to re-provision the service to avoid using the local DN AF/AS.

At step 2310, the service content flows from the UE directly to the remote DN AF/AS.

Although FIG. 23 illustrates one example method 2300 for a service update to avoid using a local DN because of bandwidth estimation, various changes may be made to FIG. 23. For example, while shown as a series of steps, various steps in FIG. 23 could overlap, occur in parallel, occur in a different order, occur any number of times, be omitted, or replaced by other steps.

In the event that connectivity between the local DN AF/AS and remote DN AF/AS is broken to the extent that the message in step 2305 of FIG. 23 does not reach the remote DN AF/AS, then the UE may not receive the end-to-end bandwidth estimation from the remote DN AF/AS for a long time.

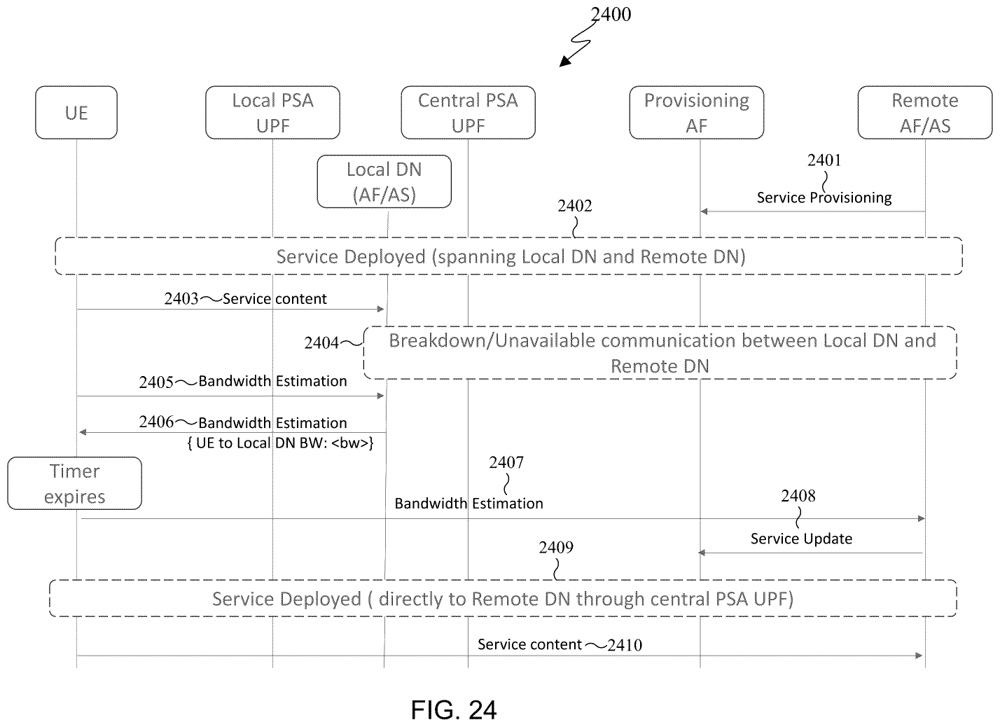

To allow the UE to infer a breakdown of connectivity between the local DN and remote DN, a timer may be configured in the UE with a reasonable expiration interval. This timer may be started upon the UE sending a bandwidth estimation request to the local DN AF/AS. When the timer expires, and if the UE has not received bandwidth estimations from the local DN and remote DN as described regarding FIG. 23, then the UE infers a breakdown of connectivity between the local DN and remote DN. In this case, there is almost no change in service configuration described in step 2308 of FIG. 23 as the remote DN AF/AS never received the bandwidth estimation request. In this situation, the UE may send a message to the remote DN AF/AS for bandwidth estimation directly, and may include the bandwidth estimation it received from the local DN AF/AS. The remote DN AF/AS may perform the service update described regarding FIG. 23 above. This process is shown in FIG. 24.

FIG. 24 illustrates an example method 2400 for a service update when a breakdown/unavailable communication between a local DN and remote DN is inferred according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for a service update when a breakdown/unavailable communication between a local DN and remote DN is inferred could be used without departing from the scope of this disclosure.

In the example of FIG. 24, method 2400 begins at step 2401. At step 2401, the ASP performs service provisioning and configuration using an MI interface.

At step 2402, the provisioning AF facilitates the setup of service.

At step 2403, the service content flows through between the UE, local DN AF/AS, and remote DN AF/AS. In some embodiments, the service content may optionally also flow through between the UE and Remote DN AF/AS if no edge computing support was sought by the ASP.

At step 2404, a breakdown/loss of connectivity between the local DN and remote DN occurs.

At step 2405, the UE makes a request for bandwidth estimation using network assistance procedures. The local DN AF/AS attempts to forward the bandwidth estimation request to the remote DN AF/AS. The local DN AF/AS, based on network measurements, estimates the available bandwidth between the UE and local DN AF/AS and provides this information in the request sent to the remote DN AF/AS.

At step 2406, the local DN AF/AS provides the above bandwidth estimation between the UE and the local DN to the UE.

At step 2407, upon expiry of timer at the UE, the UE requests the remote DN AF/AS for a bandwidth estimation directly, and may include the bandwidth estimation it received from the local DN.

At step 2408, the Remote DN AF/AS may sense the connectivity issue between the local DN and remote DN due to the incoming request from the UE, and may provide a service update configuration to the provisioning AF. The service update provisioning information may indicate that the provisioning AF is to terminate the session through the Local DN AF/AS and instead only have a direct session between the UE and remote DN AF/AS.

At step 2409, the provisioning AF communicates with other network entities in the operator network to re-provision the service to avoid using the local DN AF/AS.

At step 2410, the service content flows from the UE directly to the remote DN AF/AS.

Although FIG. 24 illustrates one example method 2400 for a service update when a breakdown/unavailable communication between a local DN and remote DN is inferred, various changes may be made to FIG. 24. For example, while shown as a series of steps, various steps in FIG. 24 could overlap, occur in parallel, occur in a different order, occur any number of times, be omitted, or replaced by other steps.

In this embodiment, described is a procedure for edge service and edge server discovery based on reachability to Remote DN.

Existing wireless networks may be based on an EdgeResourceConfiguration data model that describes the type of edge resources that the ASP intends the mobile network operator to provision for edge sessions serving edge media applications. The EdgeResourceConfiguration data model specifies easRequirements that describe the requirements of the EAS profile that is used for discovery of appropriate edge services/servers to serve media streaming sessions. In various embodiments of the present disclosure, the easRequirements may include the enhancements shown in Table 4 so that appropriate edge application servers/services are discovered based on reachability considerations to a Remote DN.

TABLE 4
easRequirements Enhancements

| Property name | Description |
|---|---|
| dnReachabilityRequirements | Specifies the DN reachability requirements. The following |
| | are the sub-properties of this information element: |
| | Remote DN AF FQDN: FQDN of Remote DN Application Function(s) |
| | Remote DN AS FQDN: FQDN of Remote DN |
| | Application Server(s) |
| | Max-latency: Maximum latency to reach the AF/AS |
| | in Remote DN |
| | Max Roundtrip Time: Maximum Round Trip Time |
| | while interacting with the Remote DN AF/AS |
| | Min-throughput: Minimum throughput while |
| | interacting with the Remote DN AF/AS |
| | Min-bandwidth: Minimum bandwidth while |
| | interacting with the Remote DN AF/AS |
| | Max-packet-loss: Maximum packet loss while |
| | interacting with the Remote DN AF/AS |
| | Max-jitter: Maximum jitter while interacting with the |
| | Remote DN AF/AS |
| | connectivity-uptime: Percentage of time the |
| | connection to Remote DN is available/guaranteed |

The ASP specifies the above DN reachability requirements by including the information in Table 4 in the service configuration/edge configuration the ASP sends to the provisioning 5GMS AF. When the provisioning AF receives this information from the ASP, the provisioning AF's EES functionality selects an EAS that satisfies the existing edge requirements and the above DN reachability requirements. The EES functionality in the provisioning AF may communicate with each EAS in the edge network to check which EAS satisfies all the requirements in media service provisioning including the above DN reachability requirements.

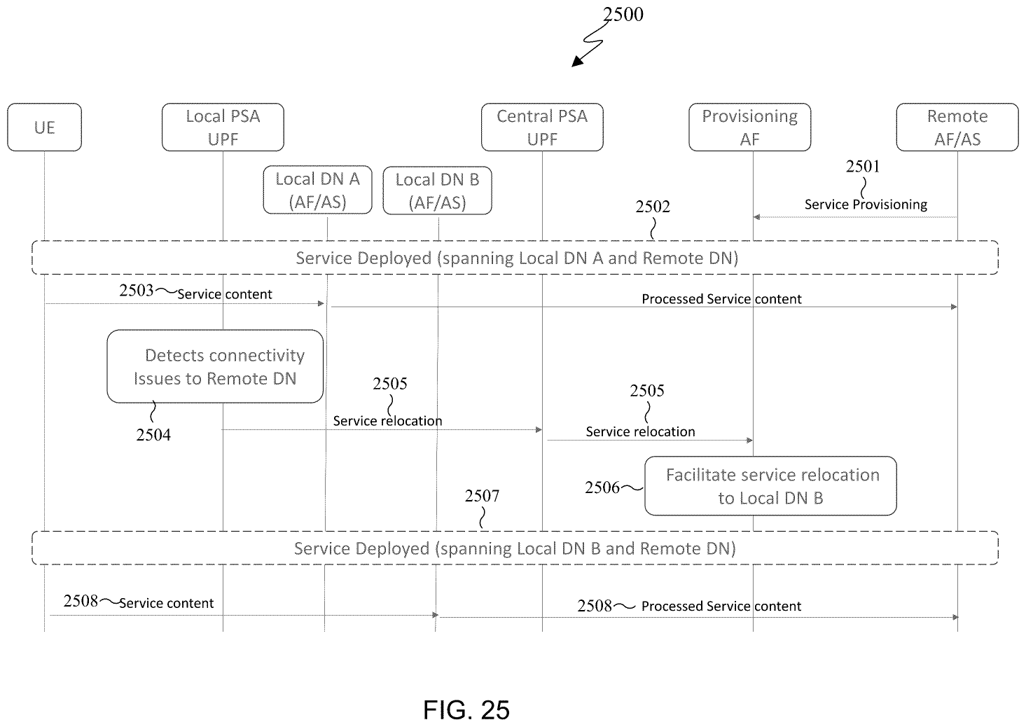

The method of FIG. 22 is a procedure for service content duplication to address connectivity issues between a local DN and a remote DN. An alternative procedure for service relocation to an alternative Local DN when there are connectivity issues between the former Local DN and the Remote DN is shown in FIG. 25.

FIG. 25 illustrates an example method 2500 for service content duplication through a local UPF and central UPF according to embodiments of the present disclosure. An embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of a method for service content duplication through a local UPF and central UPF could be used without departing from the scope of this disclosure.

In method 2500, the ASP performs the service configuration with required end-to-end QoS/QoE requirements, and the network adapts to changing network conditions to facilitate service relocation to an alternate local DN to avoid failing of processing at both the local DN and remote DNs.

Method 2500 begins at step 2501. At step 2501, the ASP performs service provisioning and configuration using an M1 interface. The service provisioning and configuration information are enhanced with the information of Table 3. The service configuration information may include a priority list of edge networks where the workloads may be deployed as described herein.

At step 2502, the provisioning AF facilitates the setup of service between the UE, Local DN, and Remote DN. The provisioning AF makes sure that the local DN “A” AF/AS is informed of the end-to-end QoS requirements for the service to run.

At step 2503, the service content flows through between the UE, local DN “A” AF/AS, and remote DN AF/AS. In some embodiments, the service content may optionally also flow through between UE and Remote DN AF/AS if no edge computing support was sought by the ASP.

At step 2504, the local site PSA UPF detects connectivity issues with the remote DN. For example, the local UPF may be informed by the local DN “A” AF/AS that the packet latencies/jitter are higher or throughput is lower etc. (i.e., local DN “A” AF/AS informs the local PSA UPF that the end-to-end QoS/QoE requirements are unable to be followed).

At step 2505, the local PSA UPF requests the central PSA UPF for service relocation as it the local PSA UPF is unable to guarantee end-to-end QoS/QoE. The central PSA UPF notifies this behavior to the provisioning AF.

At step 2506, the provisioning AF facilitates service relocation to local DN “B” by communicating with other network functions in the mobile operator network.

At step 2507, service is re-provisioned for service content to flow through local DN “B”.

At step 2508, service content is transmitted directly in between the UE, local DN “B” AF/AS, and the remote DN AF/AS.

Although FIG. 25 illustrates one example method 2500 for service content duplication through a local UPF and central UPF, various changes may be made to FIG. 25. For example, while shown as a series of steps, various steps in FIG. 25 could overlap, occur in parallel, occur in a different order, occur any number of times, be omitted, or replaced by other steps.

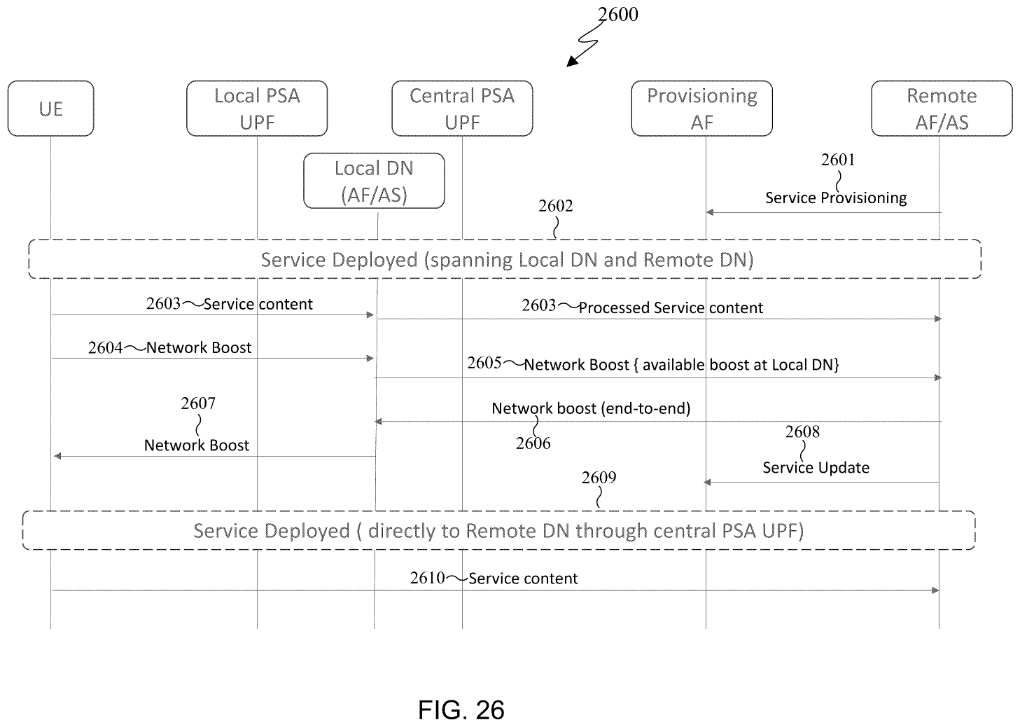

The method of FIG. 24 is a procedure for bandwidth estimation from the UE to detect connectivity issues between the Local DN and Remote DN. An alternative procedure is shown in FIG. 26 that instead of using the bandwidth estimation, uses a network boost procedure.

FIG. 26 illustrates an example method 2600 for a service update when a breakdown/unavailable communication between a local DN and remote DN is inferred according to embodiments of the present disclosure. An embodiment of the method illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of a method for a service update when a breakdown/unavailable communication between a local DN and remote DN is inferred could be used without departing from the scope of this disclosure.

Method 2600 beings at step 2601. At step 2601 the ASP performs service provisioning and configuration using an M1 interface.

At step 2602, the provisioning AF facilitates the setup of service.

At step 2603, the service content flows through between the UE, local DN AF/AS, and remote DN AF/AS. In some embodiment, the service content may optionally also flow through between UE and remote DN AF/AS if no edge computing support was sought by the ASP.

At step 2604, the UE transmits a request for a network boost for its application flows using network assistance procedures.

At step 2605, the local DN AF/AS forwards the boost request to the remote DN AF/AS. The local DN AF/AS, based on network measurements, estimates the available network boost it can grant to the UE, and provides this information in the request sent to the remote DN AF/AS. The local DN AF/AS may optionally return this information back to the UE.

At step 2606, upon receiving the network boost request from the local DN AF/AS, the remote DN AF/AS based on network measurements, estimates the end-to-end network boost it can provide to the UE. The remote DN AF/AS provides this information to the local DN AF/AS.

At step 2607, the local DN AF/AS, upon receiving the information from the remote AF/AS, calculates the final network boost it can grant to the UE, and sends this information to the UE. For example, the final network boost may be the minimum of network boosts computed at the local DN and remote DN.

At step 2608, the remote DN AF/AS may sense a connectivity issue due to the network boost, and may provide a service update configuration to the provisioning AF. The service update provisioning information may indicate that the provisioning AF is to terminate the session through local DN AF/AS and instead only have a direct session from the UE to the remote DN AF/AS.

At step 2609, the provisioning AF, communicates with other network entities in the operator network to re-provision the service to avoid using the local DN AF/AS.

At step 2610, the service content flows from the UE directly to the remote DN AF/AS.

Although FIG. 26 illustrates one example method 2600 for a service update when a breakdown/unavailable communication between a local DN and remote DN is inferred, various changes may be made to FIG. 26. For example, while shown as a series of steps, various steps in FIG. 26 could overlap, occur in parallel, occur in a different order, occur any number of times, be omitted, or replaced by other steps.

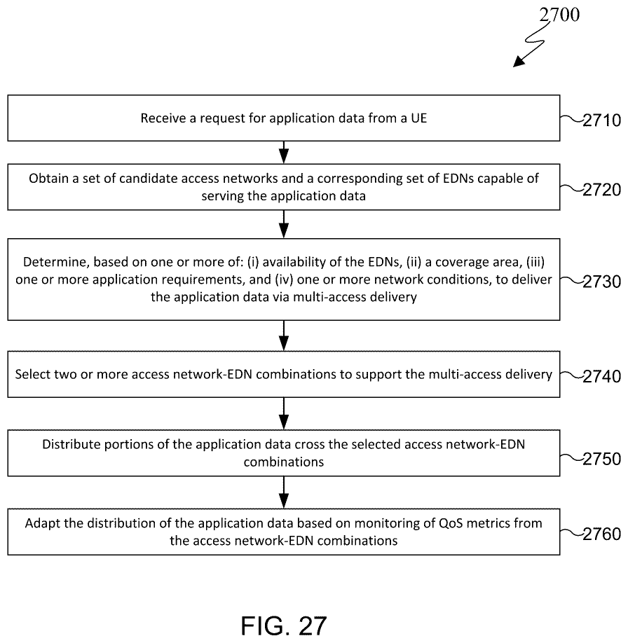

FIG. 27 illustrates an example method 2700 for edge computing with multi-access delivery according to embodiments of the present disclosure. An embodiment of the method illustrated in FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments of a method for edge computing with multi-access delivery could be used without departing from the scope of this disclosure.

In the example of FIG. 27, method 2700 begins at step 2710, at step 2710, an apparatus (such as AF 1804 if FIG. 18) receives a request for application data from a UE.

At step 2720, the apparatus obtains a set of candidate access networks and a corresponding set EDNs capable of serving the application data.

At step 2730, the apparatus determines, based on one or more of: (i) availability of the EDNs, (ii) a coverage area, (iii) one or more application requirements, and (iv) one or more network conditions, to deliver the application data via multi-access delivery.

At step 2740, the apparatus selects two or more access network-EDN combinations to support the multi-access delivery.

At step 2750, the apparatus distributes portions of the application data across the selected access network-EDN combinations.

At step 2760, the apparatus adapts the distribution of the application data based on monitoring of QoS metrics for the access network-EDN combinations.

In some embodiments, the apparatus may evaluate at least one of: (i) proximity of the EDNs to the UE, (ii) one or more user subscription policies, and (iii) availability of compute offload capabilities at the EDNs, and select two or more access network-EDN combinations based, at least in part, on a difference of one or more of: (i) processing capabilities, (ii) content localization, or (iii) latency guarantees offered by edge application servers associated with different EDNs within the set of EDNs reachable through different access networks.

In some embodiments, the apparatus may receive, from the UE, an indication that the UE has a capability to access multiple access networks, and provision a flow of the application data across the selected access network-EDN combinations to maximize a user experience. In these embodiments, the provisioning may include one or more of (i) flow splitting, (ii) encoding optimization, and (iii) session duplication.

In some embodiments, the QoS metrics include one or more of (i) a performance of an application associated with the application data, and (ii) a utilization of the EDNs, and to adapt the distribution of the application data, the apparatus may identify, based on the monitoring of the QoS metrics, a performance degradation associated with one or more of the selected access network-EDN combinations, and reprovision at least a portion of the flow of the application data across an alternate access network-EDN combination to maintain or improve the QoS metrics.

In some embodiments, in response to initiation of an adaptation of the distribution of the application data, the apparatus may determine that application state continuity is to be preserved, initiate a transfer or duplication of an application state associated with application data provisioned to a source edge application server in a first EDN in the set of EDNs to a target edge application server in a second EDN of the set of EDNs, and deliver the application data provisioned to the source edge application server in a first EDN from the target edge application server in the second EDN using the transferred or duplicated application state.

In some embodiments, the apparatus may detect a connectivity state between a local DN and a remote DN, and store or report the detected connectivity state to a PCF or an AF for use in traffic routing decisions.

In some embodiments, the apparatus may upon detection of connectivity between the local DN and the remote DN, trigger, based on one or more of a service policy and an application context, a change in a delivery mode from (i) a single-access delivery mode to a multi-access delivery mode, or (ii) a multi-access delivery mode to a single-access delivery mode.

Although FIG. 27 illustrates one example method for method 2700 for edge computing with multi-access delivery, various changes may be made to FIG. 27. For example, while shown as a series of steps, various steps in FIG. 27 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An apparatus comprising:
a transceiver configured to receive a request for application data from a user equipment (UE);
a processor operably coupled to the transceiver, the processor configured to:
obtain a set of candidate access networks and a corresponding set of edge data networks (EDNs) capable of serving the application data;
determine, based on one or more of: (i) availability of the EDNs, (ii) a coverage area, (iii) one or more application requirements, and (iv) one or more network conditions, to deliver the application data via multi-access delivery;
select two or more access network-EDN combinations to support the multi-access delivery;
distribute portions of the application data across the selected access network-EDN combinations; and
adapt the distribution of the application data based on monitoring of quality of service (QOS) metrics for the access network-EDN combinations.

2. The apparatus of claim 1, wherein the processor is further configured to:
evaluate at least one of: (i) proximity of the EDNs to the UE, (ii) one or more user subscription policies, and (iii) availability of compute offload capabilities at the EDNs; and
select two or more access network-EDN combinations based, at least in part, on a difference of one or more of: (i) processing capabilities, (ii) content localization, or (iii) latency guarantees offered by edge application servers associated with different EDNs within the set of EDNs reachable through different access networks.

3. The apparatus of claim 1, wherein:
the transceiver is further configured to receive, from the UE, an indication that the UE has a capability to access multiple access networks; and
the processor is further configured to provision a flow of the application data across the selected access network-EDN combinations to maximize a user experience, wherein the provisioning includes one or more of (i) flow splitting, (ii) encoding optimization, and (iii) session duplication.

4. The apparatus of claim 3, wherein:
the QoS metrics include one or more of (i) a performance of an application associated with the application data, and (ii) a utilization of the EDNs; and
to adapt the distribution of the application data, processor is further configured to:
identify, based on the monitoring of the QoS metrics, a performance degradation associated with one or more of the selected access network-EDN combinations; and
reprovision at least a portion of the flow of the application data across an alternate access network-EDN combination to maintain or improve the QoS metrics.

5. The apparatus of claim 1, wherein the processor is further configured to, in response to initiation of an adaptation of the distribution of the application data:
determine that application state continuity is to be preserved;
initiate a transfer or duplication of an application state associated with application data provisioned to a source edge application server in a first EDN in the set of EDNs to a target edge application server in a second EDN of the set of EDNs; and
deliver the application data provisioned to the source edge application server in a first EDN to the target edge application server in the second EDN using the transferred or duplicated application state.

6. The apparatus of claim 1, wherein the processor is further configured to:
detect a connectivity state between a local data network (DN) and a remote DN; and
store or report the detected connectivity state to a policy control function (PCF) or an application function (AF) for use in traffic routing decisions.

7. The apparatus of claim 6, wherein the processor is further configured to, upon detection of connectivity between the local DN and the remote DN, trigger, based on one or more of a service policy and an application context, a change in a delivery mode from (i) a single-access delivery mode to a multi-access delivery mode, or (ii) a multi-access delivery mode to a single-access delivery mode.

8. A method of operating an apparatus, the method comprising:
receiving a request for application data from a user equipment (UE);
obtaining a set of candidate access networks and a corresponding set of edge data networks (EDNs) capable of serving the application data;
determining, based on one or more of: (i) availability of the EDNs, (ii) a coverage area, (iii) one or more application requirements, and (iv) one or more network conditions, to deliver the application data via multi-access delivery;
selecting two or more access network-EDN combinations to support the multi-access delivery;
distributing portions of the application data across the selected access network-EDN combinations; and
adapting the distribution of the application data based on monitoring of quality of service (QoS) metrics for the access network-EDN combinations.

9. The method of claim 8, further comprising:
evaluating at least one of: (i) proximity of the EDNs to the UE, (ii) one or more user subscription policies, and (iii) availability of compute offload capabilities at the EDNs; and
selecting two or more access network-EDN combinations based, at least in part, on a difference of one or more of: (i) processing capabilities, (ii) content localization, or (iii) latency guarantees offered by edge application servers associated with different EDNs within the set of EDNs reachable through different access networks.

10. The method of claim 8, further comprising:
receiving, from the UE, an indication that the UE has a capability to access multiple access networks; and
provisioning a flow of the application data across the selected access network-EDN combinations to maximize a user experience, wherein the provisioning includes one or more of (i) flow splitting, (ii) encoding optimization, and (iii) session duplication.

11. The method of claim 10, wherein:
the QoS metrics include one or more of (i) a performance of an application associated with the application data, and (ii) a utilization of the EDNs; and
to adapt the distribution of the application data, the method further comprises:
identifying, based on the monitoring of the QoS metrics, a performance degradation associated with one or more of the selected access network-EDN combinations; and
reprovisioning at least a portion of the flow of the application data across an alternate access network-EDN combination to maintain or improve the QoS metrics.

12. The method of claim 8, further comprising, in response to initiation of an adaptation of the distribution of the application data:
determining that application state continuity is to be preserved;
initiating a transfer or duplication of an application state associated with application data provisioned to a source edge application server in a first EDN in the set of EDNs to a target edge application server in a second EDN of the set of EDNs; and
delivering the application data provisioned to the source edge application server in a first EDN to the target edge application server in the second EDN using the transferred or duplicated application state.

13. The method of claim 8, further comprising:
detecting a connectivity state between a local data network (DN) and a remote DN; and
storing or reporting the detected connectivity state to a policy control function (PCF) or an application function (AF) for use in traffic routing decisions.

14. The method of claim 13, further comprising, upon detection of connectivity between the local DN and the remote DN, triggering, based on one or more of a service policy and an application context, a change in a delivery mode from (i) a single-access delivery mode to a multi-access delivery mode, or (ii) a multi-access delivery mode to a single-access delivery mode.

15. A non-transitory computer readable medium embodying a computer program comprising program code that, when executed by a processor of a device, causes the device to:
receive a request for application data from a user equipment (UE);
obtain a set of candidate access networks and a corresponding set of edge data networks (EDNs) capable of serving the application data;
determine, based on one or more of: (i) availability of the EDNs, (ii) a coverage area, (iii) one or more application requirements, and (iv) one or more network conditions, to deliver the application data via multi-access delivery;
select two or more access network-EDN combinations to support the multi-access delivery;
distribute portions of the application data across the selected access network-EDN combinations; and
adapt the distribution of the application data based on monitoring of quality of service (QOS) metrics for the access network-EDN combinations.

16. The non-transitory computer readable medium of claim 15, wherein the computer program includes program code, that when executed by the processor of the device, causes the device to:
evaluate at least one of: (i) proximity of the EDNs to the UE, (ii) one or more user subscription policies, and (iii) availability of compute offload capabilities at the EDNs; and
select two or more access network-EDN combinations based, at least in part, on a difference of one or more of: (i) processing capabilities, (ii) content localization, or (iii) latency guarantees offered by edge application servers associated with different EDNs within the set of EDNs reachable through different access networks.

17. The non-transitory computer readable medium of claim 15, wherein the computer program includes program code, that when executed by the processor of the device, causes the device to:
receiving, from the UE, an indication that the UE has a capability to access multiple access networks; and
provisioning a flow of the application data across the selected access network-EDN combinations to maximize a user experience, wherein the provisioning includes one or more of (i) flow splitting, (ii) encoding optimization, and (iii) session duplication.

18. The non-transitory computer readable medium of claim 17, wherein:
the QoS metrics include one or more of (i) a performance of an application associated with the application data, and (ii) a utilization of the EDNs; and
to adapt the distribution of the application data, the computer program includes program code, that when executed by the processor of the device, causes the device to:
identify, based on the monitoring of the QoS metrics, a performance degradation associated with one or more of the selected access network-EDN combinations; and
reprovision at least a portion of the flow of the application data across an alternate access network-EDN combination to maintain or improve the QoS metrics.

19. The non-transitory computer readable medium of claim 15, wherein the computer program includes program code, that when executed by the processor of the device, causes the device to, in response to initiation of an adaptation of the distribution of the application data:
determine that application state continuity is to be preserved;
initiate a transfer or duplication of an application state associated with application data provisioned to a source edge application server in a first EDN in the set of EDNs to a target edge application server in a second EDN of the set of EDNs; and
deliver the application data provisioned to the source edge application server in a first EDN from the target edge application server in the second EDN using the transferred or duplicated application state.

20. The non-transitory computer readable medium of claim 15, wherein the computer program includes program code, that when executed by the processor of the device, causes the device to:
detect a connectivity state between a local data network (DN) and a remote DN;
store or report the detected connectivity state to a policy control function (PCF) or an application function (AF) for use in traffic routing decisions; and
upon detection of connectivity between the local DN and the remote DN, trigger, based on one or more of a service policy and an application context, a change in a delivery mode from (i) a single-access delivery mode to a multi-access delivery mode, or (ii) a multi-access delivery mode to a single-access delivery mode.
